(19) United States
(12) Patent Application Publication
(10) Pub. No.: US 2006/0028082 A1
(43) Pub. Date: Feb. 9, 2006

(54) Interior permanent magnet electric rotating machine

(75) Inventors: Koji Asagara, Anjo-shi (JP); Yoriaki Ando, Nagoya (JP); Soichi Yoshinaga, Nagoya (JP)

Correspondence Address: OLIFF & BERRIDGE, PLC, P.O. BOX 19928, ALEXANDRIA, VA, 22320, US

(73) Assignees: DENSO CORPORATION, Kariya-city (JP); NIPPON SOKEN, INC., Nishio-city (JP)

(21) Appl. No.: 11/195,795

(22) Filed: Aug. 3, 2005

(30) Foreign Application Priority Data
Aug. 3, 2004 (JP) 2004-226720

(51) Int. Cl. H02K 1/27

(52) U.S. Cl. 310/156.53

(57) ABSTRACT

An interior permanent magnet electric rotating machine is configured such that either at least one of first intervals between first flux direction regulation portions of a plurality of first flux barriers provided in a rotor core of the machine or at least one of second intervals between second flux direction regulation portions of a plurality of second flux barriers provided in the rotor core is different from corresponding at least one of the remaining first intervals therebetween or at least one of the remaining second intervals therebetween.

### BACKGROUND OF THE INVENTION

### CROSS REFERENCE TO RELATED APPLICATION

This application is based on Japanese Patent Application 2004-226720 filed on Aug. 3, 2004 and claims the benefit of priority therefrom, so that the descriptions of which are all incorporated herein by reference.

1. Field of the Invention

The present invention relates to interior permanent magnet electric rotating machines, such as interior permanent magnet synchronous motors, for reducing magnetic noises.

2. Description of the Related Art

Interior permanent magnet (IPM) electric rotating machines (IPM machines) have a rotor in which permanent magnets are embedded; this rotor serves as a rotational magnetic flux creating member. These IPM machines have a high degree of efficiency and a compact size. This is because the IPM machines can use, as motor torque, reluctance torque caused by the differences of magnetic resistances of outer peripheral portions of the rotor in addition to magnetic torque generated by the magnetic fluxes of the permanent magnets. These advantages of the IPM machines allow the machines to have great potential in fields that require reduction in size and weight and a high degree of efficiency.

As an example of these IPM machines, an IPM synchronous motor is disclosed in U.S. patent Publication No. 6,404,152 corresponding to Japanese Unexamined Patent Publication No. H11-341864.

In conventional IPM synchronous motors, odd-order harmonics as magnetic noises of a phase-current's frequency (fundamental frequency) may appear remarkably in a frequency spectrum range with high auditory sensitivity, such as the frequency spectrum range between 1 kHz and 5 kHz. For example, assuming that the rotation speed of the rotor is 3000 rpm, magnetic noises with 1.2 kHz may appear in the frequency spectrum range between 1 kHz and 5 kHz.

In order to solve this problem, the U.S. patent Publication adjusts the waveform of a stator current to reduce magnetic noises.

The method of adjusting the waveform of the stator-current to reduce the magnetic noises set fort above may require high-speed and complicated control circuits because the frequencies, phases, and amplitudes of the magnetic noises vary with the change of the stator current's waveform. In addition, in the adjustment method, adjustment of the stator current's waveform may increase torque ripples and power consumption.

### SUMMARY OF THE INVENTION

The present invention has been made on the background set forth above. Specifically, at least one preferable embodiment of the present invention provides interior permanent magnet electric rotating machines capable of reducing magnetic noises without adjusting the waveform of a stator current.

According to one aspect of the present invention, there is provided an interior permanent magnet electric rotating machine. The machine includes a stator core having a plurality of teeth circumferentially arranged with regular intervals; and a rotor core with a periphery arranged to be opposite to a periphery of each of the teeth of the stator core with a predetermined air gap, the rotor core being supported to the rotating machine to be rotatable around the periphery of each of the teeth of the stator core. The rotor core includes a plurality of permanent magnets embedded in a plurality of slits, the plurality of slits being formed in the interior of the rotor core and circumferentially arranged to be opposite to the periphery of the rotor core with predetermined intervals. The rotor core includes a plurality of first flux barriers each having a first barrier portion and a fist flux direction regulation portion. Each of the first barrier portions is at least close to one circumferential end of each of the slits. The first flux direction regulation portions are circumferentially arranged with predetermined first intervals. Each of the first flux direction regulation portions is closely opposite to a first region of the periphery of the rotor core with a predetermined thickness portion therebetween. Each of the first flux regulation portions is configured to regulate a direction of a magnetic flux flowing through the predetermined thickness portion and to change a first magnetic flux density on the first region of the periphery of the rotor core. The rotor core includes a plurality of second flux barriers each having a second barrier portion and a second flux direction regulation portion. Each of the second barrier portions is at least close to the other circumferential end of each of the slits, the second flux direction regulation portions being circumferentially arranged with predetermined second intervals. Each of the second flux direction regulation portions is closely opposite to a second region of the periphery of the rotor core with a predetermined thickness portion therebetween. Each of the second flux regulation portions is cored to regulate a direction of a magnetic flux flowing through the predetermined thickness portion and to change a second magnetic flux density on the second region of the periphery of the rotor core. The rotor core includes a plurality of q-axis flux passing portions arranged between the first and second flux barriers, respectively, and configured to radially guide q-axis magnetic fluxes therethrough. At least one of the first intervals or at least one of the second intervals is different from corresponding at least one of the remaining first intervals or at least one of the remaining second intervals.

According to another aspect of the present invention, there is provided an interior permanent magnet electric rotating machine. The machine includes a stator core having a plurality of teeth circumferentially arranged with regular intervals; and a rotor core with a periphery arranged to be opposite to a periphery of each of the teeth of the stator core with a predetermined air gap, the rotor core being supported to the rotating machine to be rotatable around the periphery of each of the teeth of the stator core. The rotor core includes a plurality of permanent magnets embedded in a plurality of slits, the plurality of slits being formed in the interior of the rotor core and circumferentially arranged to be opposite to the periphery of the rotor core with predetermined intervals. The rotor core includes a plurality of first flux barriers each having a first barrier portion and a first flux direction regulation portion. Each of the first barrier portions is at least close to one circumferential end of each of the slits. The first flux direction relation portions are circumferentially arranged with predetermined first intervals. Each of the first flux direction regulation portions is closely opposite to a first region of the periphery of the rotor core with a predetermined thickness portion therebetween. Each of the first flux regulation portions is configured to regulate a direction of a magnetic flux flowing through the predetermined thickness portion and to change a first magnetic flux density on the first region of the periphery of the rotor core. The rotor core includes a plurality of second flux barriers each having a second barrier portion and a second flux direction regulation portion. Each of the second barrier portions is at least close to the other circumferential end of each of the slits, the second flux direction regulation portions being circumferentially arranged with predetermined second intervals. Each of the second flux direction regulation portions is closely opposite to a second region of the periphery of the rotor core with a predetermined thickness portion therebetween. Each of the second flux regulation portions is configured to regulate a direction of a magnetic flux flowing through the predetermined thickness portion and to change a second magnetic flux density on the second region of the periphery of the rotor core. The rotor core includes a plurality of q-axis flux passing portions arranged between the first and second flux barriers, respectively, and configured to radially guide q-axis magnetic fluxes therethrough. When at least one of the first regions has passed directly in front of the periphery of one of the teeth for a predetermined time interval, the at least one of the first regions creates first change of magnetic fluxes through the periphery of the one of the teeth, and at least one of the second regions adjacent to the at least one of the first regions creates second change of magnetic fluxes through the periphery of another one of the teeth during the time interval. Another one of the teeth is close to the at least one of the second regions during the time interval. When the first change is represented as ΔΦa and the second change is represented as ΔΦb, the at least one of the first regions and the at least one of the second regions adjacent thereto are arranged such that an absolute value of the sum of the first change ΔΦa and the second change ΔΦb is not more than any one of an absolute value of the first change ΔΦa and an absolute value of the second change ΔΦb.

According to a further aspect of the present invention, there is provided an interior permanent magnet electric rotating machine. The machine includes a stator core having a plurality of teeth circumferentially arranged with regular intervals; and a rotor core with a periphery arranged to be opposite to a periphery of each of the teeth of the stator core with a predetermined air gap, the rotor core being supported to the rotating machine to be rotatable around the periphery of each of the teeth of the stator core. The rotor core includes a plurality of permanent magnets embedded in a plurality of slits, the plurality of slits being formed in the interior of the rotor core and circumferentially arranged to be opposite to the periphery of the rotor core with predetermined intervals. The rotor core includes a plurality of first flux barriers each having a first barrier portion and a first flux direction regulation portion. Each of the first barrier portions is at least close to one circumferential end of each of the slits. The first flux direction regulation portions are circumferentially arranged with predetermined first intervals. Each of the first flux direction regulation portions is closely opposite to a fist region of the periphery of the rotor core with a predetermined thickness portion therebetween. Each of the first flux regulation portions is configured to regulate a direction of a magnetic flux flowing through the predetermined thickness portion and to change a first magnetic flux density on the first region of the periphery of the rotor core. The rotor core includes a plurality of second flux barriers each having a second barrier portion and a second flux direction regulation portion. Each of the second barrier portions is at least close to the other circumferential end of each of the slits, the second flux direction regulation portions being circumferentially arranged with predetermined second intervals. Each of the second flux direction regulation portions is closely opposite to a second region of the periphery of the rotor core with a predetermined thickness portion therebetween. Each of the second flux regulation portions is configured to regulate a direction of a magnetic flux flowing through the predetermined thickness portion and to change a second magnetic flux density on the second region of the periphery of the rotor core. The rotor core includes a plurality of q-axis flux passing portions arranged between the first and second flux barriers, respectively, and configured to radially guide q-axis magnetic fluxes therethrough. Each of the thickness portions corresponding to the first and second flux direction regulation portions has a circumferential width, the circumferential width being 0.6 to 0.9 times a circumferential width of each of the teeth.

### BRIEF DESCRIPTION OF THE DRAWINGS

Other objects and aspects of the invention will become apparent from the following description of embodiments with reference to the accompanying drawings in which;

FIG. 1 is a sectional view schematically illustrating the structure of the half of an interior permanent magnet motor according to a first embodiment of the present invention;

FIG. 2 is an enlarged cross sectional view schematically illustrating part of the peripheral portion of a rotor core of the interior permanent magnet motor shown in FIG. 1: this part is schematically developed in the circumferential direction of the rotor core;

FIG. 3 is a view schematically illustrating the change of fluxes through an inner periphery of any one of teeth when first and second magnetic-pole density change regions pass by the inner periphery thereof in a circumferential direction with the rotation of the rotor core at a predetermined fundamental frequency;

FIG. 4 is a sectional view schematically illustrating the structure of the half of an interior permanent magnet motor according to a first modification of the first embodiment of the present invention;

FIG. 5 is an enlarged cross sectional view schematically illustrating part of the peripheral portion of a rotor core of the interior permanent magnet motor shown in FIG. 1;

FIG. 6 is a sectional view schematically illustrating the structure of a four divided rotor according to a second modification of the first embodiment of the present invention;

FIG. 7 is a sectional view schematically illustrating the structure of a four-divided rotor according to a second modification of the first embodiment of the present invention;

FIG. 8 is an enlarged cross sectional view schematically illustrating part of a peripheral portion of a rotor core of an IPM motor according to a second embodiment of the invention;

FIG. 9 is a view schematically illustrating change of magnetic flu densities through teeth 91, 95, and 97 illustrated in FIG. 8;

FIG. 10 is a sectional view schematically illustrating the structure of the half of an interior permanent magnet motor according to an example of the second embodiment of the present invention;

FIG. 11 is an enlarged cross sectional view schematically illustrating part of the peripheral portion of a rotor core of the interior permanent magnet motor shown in FIG. 10;

FIG. 12 is a graph illustrating a first test result according to the first embodiment of the present invention; and

FIG. 13 is a graph illustrating a second test result according to the first to third modifications of the first embodiment of the present invention.

### DETAILED DESCRIPTION OF EMBODIMENTS OF THE INVENTION

Embodiments and their modifications of the present invention will be described hereinafter with reference to the accompanying drawings.

### First Embodiment

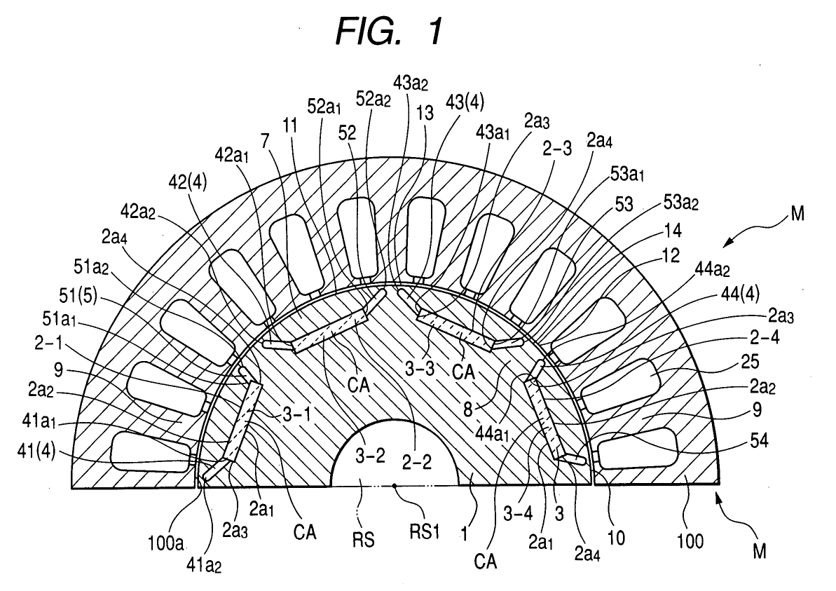

FIG. 1 schematically illustrates the structure of the half of an interior permanent magnet synchronous motor M as an example of interior permanent magnet electric rotating machines according to a first embodiment of the present invention. Hereinafter, the interior permanent magnet synchronous motor is referred to simply as “IPM motor”.

As illustrated in FIG. 1, the IPM motor M is designed to a three-phase inner-rotor (outer-stator) motor.

Specifically, the IPM motor M is provided with a cylindrical rotating shaft RS and a rotor core 1 with soft magnetism and an annular shape in its lateral cross section. The rotor core 1 is made of, for example, a laminated-electromagnetic steel plate and is fixedly fitted around the outer periphery of the rotating shaft RS. Incidentally, the rotor core 1 can be integrated with the rotating shaft RS.

The IPM motor M is also provided with a stator core 100 with an annular shape in its lateral cross section. The stator core 100 is disposed around the outer periphery 10 of the rotor core 1 such that the inner periphery 100a of the stator core 100 is opposite to the outer periphery 10 of the rotor core 1 with a predetermined air gap.

The rotor core 1 is provided with a plurality of magnet retaining slits 2-1, 2-2, . . . penetrated therethrough so as to parallely end along the axial direction of the rotor core 1 and each having, for example, a substantially rectangular shape in its lateral cross section. Note that the magnet retaining slits 2-1, 2-2, . . . are collectively referred to as “slits 2”.

The distance between the center axis RS1 of the rotor core 1 (the rotating shaft RS) and the center axis CA of each of the slits 2 in the same cross-section is, for example, constant. For example, each of the slits 2 is arranged such that a pair of first and second longitudinal inner walls 2a1 and 2a2 opposite in parallel to each other is orthogonal to the radius direction of the rotor core 1 passing through the center axis CA of each of the slits 2.

The slits 2 are arranged apart from the outer periphery 10 of the rotor core 1 at regular spaces between the center axes CA of the slits 2 and the outer periphery 10 along the radial directions passing through the corresponding center axes CA in the same cross-section, respectively.

In addition, each of the slits 2 has a pair of first and second lateral end portions 2a3 and 2a4 opposite to each other.

In FIG. 1, slits 2-1, 2-2, 2-3, and 2-4, which are sequentially arranged, in all of the slits 2 are illustrated. The first lateral end portions 2a3 of the slits 2-1, 2-2, 2-3, and 2-4 are arranged in the circumferential direction of the rotor core 1 with regular spaces each corresponding to an electrical angle of π of the rotor core 1.

Moreover, the rotor core 1 is provided with a plurality of flat-plate like permanent magnets 3-1, 3-2, . . . , each having substantially the same shape as the inner space of each slit 2 in its lateral cross section. Note that the magnets 3-1, 3-2, . . . are collectively referred to as “permanent magnets 3”. The permanent magnets 3 are inserted to be fitted in the slits 2, respectively, such that the center axis of each permanent magnet 3 corresponds to the center axis CA of each slit 2. For example, each of the permanent magnets 3 has a substantially symmetrical shape with respect to the radial direction passing through the center axis thereof.

Each of the permanent magnets 3 has a pair of principal planes (longitudinal planes) corresponding to the first and second longitudinal inner walls 2a1 and 2a2 of each of the slits 2, and a pair of lateral end portions corresponding to the first and second lateral end portions 2a3 and 2a4 of each of the slits 2.

The thickness direction of each of the permanent magnets 3 corresponds to the radial direction passing through the center axis of each of the permanent magnets 3. The width direction of each of the permanent magnets 3 is parallel to the tangential direction of the outer periphery of the rotor core 1; this tangential direction is orthogonal to the radial direction passing through the center axis of each of the permanent magnets 3.

Preferably, the principle planes of each of the permanent magnets 3 are magnetized in their thickness directions to serve as magnetic poles with opposing magnetic polarities, such as N and S poles, respectively. The rotor core 1 is configured such that the N and S poles of the permanent magnets 3 are alternately arranged in the circumferential direction.

The rotor core 1 is provided with a plurality of first flux barriers, such as slits, 4, and a plurality of second flux barriers, such as slits 5. Each of the first and second flux barriers 4 and 5 is penetrated through the rotor core 1 so as to parallely extend along the axial direction thereof. Each of the first and second flux barriers 4 and 5 has a substantially linear shape in its lateral cross section. The flus barriers 4 and 5 work to prevent magnetic fluxes of the permanent magnets 3 from being short-circuited to each other in the rotor core 1 without through the stator core 100.

In FIG. 1, first flux barriers 41 to 44 in all of the first flux barriers 4 are illustrated, and second flux barriers 51 to 54 in all of the second flux barriers 5 are illustrated therein.

One end 41a1 of the first flux barrier 41 is connected to be communicated with the first lateral end portion 2a3 of the slit 2-1, and the other end 41a2 of the first flux barrier 41 extends obliquely outwardly close to the outer periphery 10 of the rotor core 1. Similarly, one ends 42a1 to 44a1 of the first flux barriers 42 to 44 are connected to be communicated with the first lateral end portions 2a3 of the slit 2-2 to 2-4, respectively. The other ends 42a2 to 44a2 of the first flux barriers 42 to 44 extend obliquely outwardly close to the outer periphery 10 of the rotor core 1, respectively.

One end 51a1 of the second flux barrier 51 is connected to be communicated with the second lateral end portion 2a4 of the slit 2-1, and the other end 51a2 of the second flux barrier 51 extends obliquely close to the outer periphery 10 of the rotor core 1. Similarly, one ends 52a1 to 54a1 of the second flux barriers 52 to 54 are connected to be communicated with the second lateral end portions 2a4 of the slit 2-2 to 2-4, respectively. The other ends 52a2 to 54a2 of the second flux barriers 52 to 54 extend obliquely close to the outer periphery 10 of the rotor core 1, respectively.

In the first embodiment, the centers C of the other ends 41a2 to 44a2 of the first flux barriers 41 to 44 and the other ends 51a2 to 54a2 of the second flux barriers 51 to 54 are arranged concentrically.

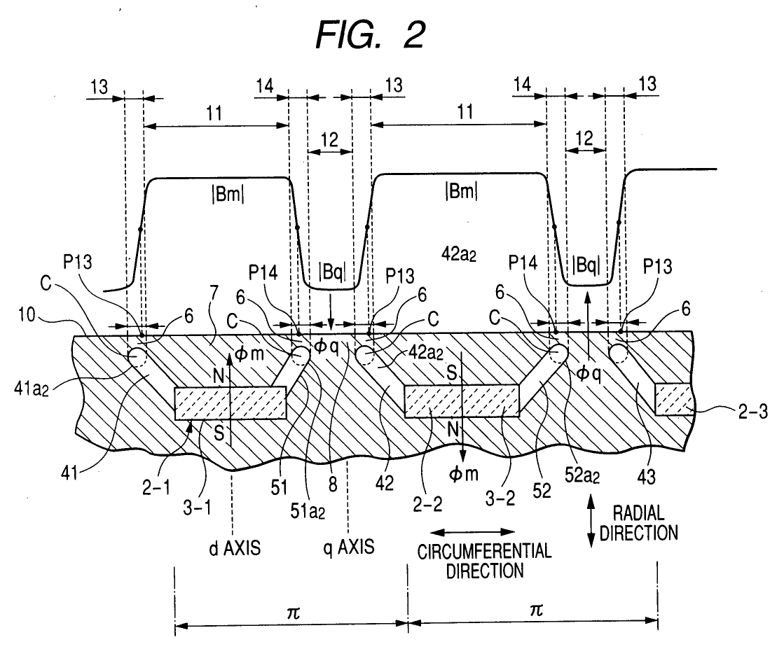

As illustrated in FIG. 2, each of the other ends 41a2 to 44a2 of the first flux barriers 4 and of the other ends 51a2 to 54a2 of the second f barriers 5 is rounded to have a substantially semicircular shape about a center axis C in its lateral cross section.

The rotor core 1 is provided with a plurality of thin-walled portions 6 formed between the outer periphery 10 of the rotor core 1 and the other ends 41a2 to 44a2 and 51a2 to 54a2 of the first and second flux barriers 41 to 44 and 51 to 54, respectively.

Specifically, as illustrated in FIG. 2, the circumferential width of the thin-walled portion 6 between the other end 41a2 of the first flux barrier 41 and the opposing outer periphery 10 of the rotor core 1 corresponds to the diameter of the other end 41a 2 of the first flux barrier 41.

Similarly, the circumferential widths of the thin-walled portions 6 between the other ends 42a2 to 44a2 of the first flux barriers 42a2 to 44a2 and the opposing outer periphery 10 of the rotor core 1 correspond to the diameters of the other ends 42a2 to 44a2 of the first flux barriers 42 to 44, respectively.

Like the first flux barriers 4, the widths of the thin-walled portions 6 between the other ends 51a2 to 54a2 of the second flux barriers 51a2 to 54a2 and the opposing outer periphery 10 of the rotor core 1 corresponds to the diameters of the other ends 512 to 54a2 of the second flux barriers 51 to 54, respectively.

Each of the other ends 41a2 to 44a2 of the first flux barriers 4 allows directions of magnetic fluxes flowing through each of the corresponding thin-walled portions 6 to be regulated in the circumferential direction. Similarly, each of the other ends 51a2 to 54a2 of the second flux barriers 5 allows directions of magnetic fluxes flowing through each of the corresponding thin-walled portions 6 to be regulated in the circumferential direction.

In addition, the rotor core 1 is provided with a plurality of q-axis flux paths (how magnetic resistance portions) 8 formed between the first flux barriers 4 and the second flux barriers 5, respectively. Specifically, the first and second flux barriers 4 and 5 provide the low magnetic resistance portions 8 therebetween in the q-axis directions orthogonal to the d-ass directions of the permanent magnets 3 (see FIG. 2). The low magnetic resistance portions 8 allow q-axis fluxes to be radially guided therethrough, respectively, to obtain reluctance torque.

In addition, the stator core 100 is provided with a plurality of slots 25 penetrated therethrough so as to parallely extend along the axial direction of the rotor core 1. The slots 25 are arranged in the circumferential direction of the stator core 100 with regular pitches. Specifically, the slots 25 provide a plurality of teeth 9 therebetween. For example, the number of slots 25 (teeth 9) is an integer multiple of the number of permanent magnets 3. In the first embodiment, the number of slots 25 (teeth 9) is three times of the number of permanent magnets 3.

The IPM motor M is further provided with three-phase stator windings (not shown), each of which is, for example, separately wound on the stator core 100. For example, each phase winding is wound in one of the slots 25 and another one of the slots 25, which is skipped over two slots 25 therefrom, so that the pitch of each phase winding corresponds to the electrical angle of π of the rotor core 1. That is, three-slot pitch corresponds to the electrical angle of π of the rotor core 1.

As illustrated in FIG. 1, the rotor core 1 is provided with a plurality of magnet adjacent portions 7 arranged between the permanent magnets 3 and the outer periphery 10 of the rotor core 1, respectively. Each of the plurality of magnet adjacent portions 7 is also arranged between both the thin-wall portions 6 adjacent thereto.

As illustrated m FIG. 2, the outer periphery 10 of the rotor core 1 has a plurality of magnetic-pole regions 11, which correspond to the outer surfaces of the magnet adjacent portions 7 to be arranged radially closely outside of the permanent magnets 3, respectively. Specifically, the permanent magnets 3 provide magnetic poles on the magnetic-pole regions 11, respectively.

The outer periphery 10 of the rotor core 1 also has a plurality of q-axis magnetic-pole regions 12 arranged radially closely outside of the low magnetic resistance portions 8, respectively. Specifically, the q-axis fluxes provide magnetic poles on the q-axis magnetic-pole regions 12, respectively.

As illustrated in FIG. 2, the permanent magnets 3 provide magnet fluxes Φm in the radial directions thereof, whose magnet polarities are alternately changed in the circumferential direction, through the corresponding magnetic-pole regions 11 with respect to the stator core 100, respective. Stator currents flowing through the three-phase windings provide the q-axis fluxes Φq through the q-axis magnetic-pole regions 12 in the radial directions thereof, whose magnet polarities are alternately changed in the circumferential direction, respectively,

As illustrated in FIG. 2, the outer periphery 10 of the rotor core 1 has a plurality of first magnetic-pole density change regions 13 corresponding to the outer peripheral surfaces of the thin-wall portions 6 adjacent to the other ends 41a2 to 44a2 of the first flux barriers 41 to 44, respectively. Similarly, the outer periphery 10 of the rotor core 1 has a plurality of second magnetic-pole density change regions 14 corresponding to the outer peripheral surfaces of the thin-wall portions 6 adjacent to the other ends 51a2 to 54a2 of the second flux barriers 51 to 54, respectively. Note that the first magnetic-pole density change regions are referred to simply as “first change regions”, hereinafter. Similarly, Note that the second magnetic-pole density change regions are referred to simply as “second change regions”, hereinafter.

The first and second change regions 13 and 14 are disposed between the magnetic-pole regions 11 and the q-axis magnetic-pole regions 12, respectively.

It is assumed that an annular core, which has soft magnetism and no slots and no stator windings, is arranged in place of the stator core 100 such that the inner periphery thereof is opposite to the outer periphery 10 of the rotor core 1 with the predetermined air gap. In this assumption, absolute value |B| of magnetic-pole density B corresponding to flux density on the outer periphery 10 of the rotor core 1 are schematically illustrated in the top of FIG. 2.

In this case, the magnetic-pole density B on the outer periphery 10 of the rotor core 1 is assumed to be substantially equal to air-gap flux density in the air gap between the outer periphery 10 of the rotor core 1 and the inner peripheries of the teeth 9.

In addition, magnetic-pole density distribution, whose magnetic polarity is reversed with respect to the polarity of the magnetic-pole density distribution on the outer periphery 10 of the rotor core 1 illustrated in FIG. 2, is assumed to be formed on the inner periphery 100a of the stator core 100. Note that the magnetic-pole density B on the outer periphery 10 of the rotor core 1 means the density of magnetic flux components through the outer periphery 10 of the rotor core 1 in the radial directions thereof, respectively. The magnetic-pole density B contains magnetic-pole density Bm on each magnetic-pole region 11, q-axis magnetic-pole density Bq on each q-axis magnetic-pole region 12, and magnetic-pole density on each of the first and second change regions 13 and 14.

In the first embodiment, the rotor core 1 is designed such that absolute value |Bₘ| of the magnetic-pole density Bm on each of the magnetic-pole regions 11 is larger than absolute value |B_{q}| of the q-axis magnetic-pole density Bq on each of the q-axis magnetic-pole regions 12. As clearly illustrated in FIG. 2, the magnetic-pole densities on the first and second change regions 13 and 14 of the outer periphery 10 of the rotor core 1 are assumed to be rapidly changed. In contrast, the magnetic-pole density Bm on each of the magnetic-pole regions 11 and q-axis magnetic-pole density Bq of each of the q-axis magnetic-pole regions 12 of the outer periphery 10 of the rotor core 1 are assumed to be substantially kept constant.

Specifically, the magnetic-pole density on each of the first and second change regions 13 and 14 generates magnetic-poles on the inner peripheries of the teeth 9 with magnetic polarities reversed with respect thereto. The magnetic-pole density on each of the first and second change regions 13 and 14 is assumed to be rapidly continuously changed between the magnetic-pole density Bm on each of the magnetic-pole regions 11 and the magnetic-pole density Bq on each of the q-axis magnetic-pole regions 12.

Assuming that the thin-walled portions 6 are substantially magnetically saturated in the circumferential direction, the amount of fluxes from the first and second change regions 13 and 14, which are applied to the teeth 9, are low, so that the thin-wall portions 6 are assumed to nonmagnetic portions, respectively.

In this assumption, because the thin-walled portions 6 can be magnetically saturated in the circumferential direction, the magnetic-pole density on each of the first and second change regions 13 and 14 is likely lower than the magnetic-pole density on each of the magnetic-pole regions 11 and the q-axis magnetic-pole density on each of the q-axis magnetic-pole regions 12.

Even if the tin-walled portions 6 are assumed to be substantially magnetically saturated in the circumferential direction, the magnetic fluxes in the air gap between the magnetic-pole regions 11 or the q-axis magnetic-pole regions 12 and the inner peripheries of the teeth 9 are likely bent to the first and second change regions 13 and 14. Thereafter, the bent magnetic fluxes are likely applied to the inner peripheries of the teeth 9, respectively.

It is assumed that the magnetic fluxes in the air gap are substantially presented in the radial directions thereof. In this assumption, the magnetic-pole density on each of the first and second change regions 13 and 14 is likely generated based on the magnetic-pole density in the radial directions of the air gap between the teeth 9 and each of the first and second change regions 13 and 14.

For these reasons, the magnetic-pole density on each of the first and second change regions 13 and 14 is assumed to be rapidly continuously changed between the magnetic-pole density Bm on each of the magnetic-pole regions 11 and the magnetic-pole density Bq on each of the q-ads magnetic-pole regions 12. Note that the q-axis magnetic-pole density can be changed with the magnitude of the stator currents.

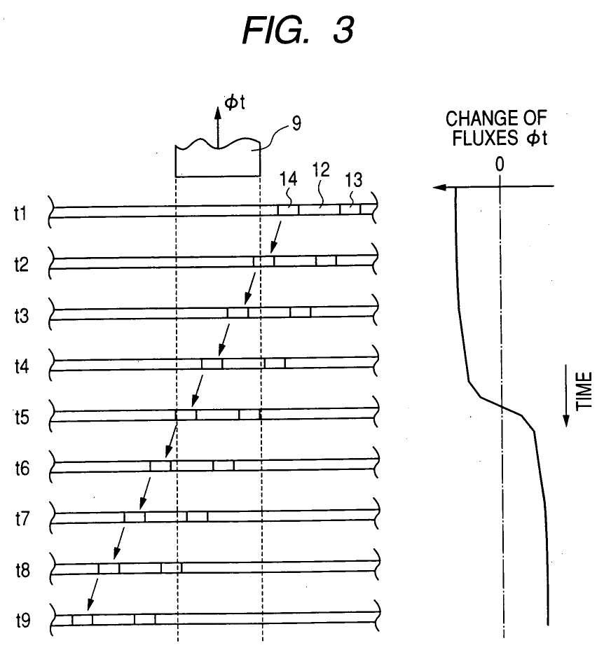

FIG. 3 schematically illustrates the change of the magnetic-pole density (magnetic fluxes in the radial directions) on the inner periphery 90 of any one of the teeth 9 when the first and second change regions 13 and 14 pass by the inner periphery 90 thereof in the circumferential direction with the rotation of the rotor core 1 at a predetermined fundamental frequency. Note that reference characters t1 to t9 in FIG. 3 schematically represent the positions of the first and second magnetic-pole density change portions 13 and 14 every constant time.

FIG. 3 shows that, when the first and second change regions 13 and 14 have passed directly in front of the inner periphery 90 of any one of the teeth 9, the first and second change regions 13 and 14 induce rapid change of the fluxes Φt through the inner periphery 90 of any one of the teeth 9 along the radial directions of the inner periphery 90 thereof.

The radially rapid change of the fluxes Φt through the inner periphery 90 of any one of the teeth 9 causes rapidly periodic change of magnetic attractive force between the outer periphery 10 of the rotor core 1 and the inner periphery 90 of any one of the teeth 9. The rapidly periodic change of the magnetic attractive force between the outer periphery 10 of the rotor core 1 and the inner periphery 90 of any one of the teeth 9 causes rapidly periodic change of radial excitation forces (vibration forces) of any one of the teeth 9.

Specifically, the sum of the radial vibration forces of each of the teeth 9 causes each of the teeth 9 to radially vibrate (expand and contract) at a predetermined frequency. The vibration of each of the teeth 9 vibrates the outer periphery of the stator core 100 through a yoke portion (core back portion) thereof. The vibration of the outer periphery of the stator core 100 vibrates external air close to the outer periphery thereof, and the vibrated external air may be irradiated from the IPM motor M as magnetic noises.

Incidentally, the thin-walled portions 6 between the outer periphery 10 of the rotor core 1 and the first and second flux barriers 4 and 5 may radially vibrate like the teeth 9.

In the first embodiment, the rotor core 1 is surrounded by the stator core 100, and the vibration of each of the thin-walled portions 6 is synchronized with the vibration of each of the teeth 9 in phase with the predetermined phase difference therebetween. For these reasons, higher-order harmonics in the magnetic noises are assumed to be generated due to only the sum of the vibration forces in the radial directions of each of the teeth 9.

Specifically, the higher-order harmonics in the magnetic noises are created based on the rapidly periodic change of the magnetic attractive force between the outer periphery 10 of the rotor core 1 and the inner periphery of each of the teeth 9. The periodic change of the attractive force is assumed to be synchronous with a period wherein at least one of the first and second change regions 13 and 14 has passed directly in front of each of the teeth 9.

As described above, in the first embodiment, because the number of teeth 9 is three times of the number of permanent magnets 3, the width of each of the magnets 3 in the circumferential direction is longer than the substantial width of the inner periphery of each of the teeth 9. For this reason, when the magnetic-pole regions 11 pass by the inner periphery of any one of the teeth 9 in the circumferential direction, the change of the flux density of any one of the teeth 9 in the radial directions thereof is likely small. For this reason, higher-order harmonics in the magnetic noises due to the change of the flux density of any one of the teeth 9 in the radial directions thereof when the magnetic-pole regions 11 pass by the inner periphery of any one of the teeth 9 in the circumferential direction would be so small as to be insignificant.

Similarly, because the magnetic-pole densities on the q-axis magnetic-pole regions 12 are substantially kept constant, when the q-axis magnetic-pole regions 12 pass by the inner periphery of any one of the teeth 9 in the circumferential direction, the change of the flux density of any one of the teeth 9 in the radial directions thereof is likely small. For this reason, higher-order harmonics in the magnetic noises due to the change of the flux density of any one of the teeth 9 in the radial directions thereof when the q-axis magnetic-pole regions 12 pass by the inner periphery of any one of the teeth 9 in the circumferential direction would be so small as to be insignificant.

As set forth above, in the IPM motor M according to the first embodiment, when the thin-walled portions 6 pass by the inner periphery 90 of any one of the teeth 9 in the circumferential direction, the magnetic-pole density on the inner periphery 90 of any one of the teeth 9 are rapidly changed. This causes the higher-order harmonics of the radial vibration forces of any one of the teeth 9 to be created.

Specifically, the change of the radial magnetic field in the air gap between one of the teeth 9 and the outer periphery 10 of the rotor core 1 from a first time to a second time can be assumed to a main factor of generation of the higher-order harmonics (magnetic noises). The fast time is when one of the magnetic-pole regions 11 is located to be directly in front of the inner periphery of the one of the teeth 9. The second time is when one of the q-axis magnetic-pole regions 12 circumferentially adjacent to the one of the magnetic-pole regions 11 is located to be directly in front of the inner periphery of the one of the teeth 9.

This change of the radial magnetic field in the air gap between one of the teeth 9 and the outer periphery 10 of the rotor core 1 is independent of the relationship between the width of each of the q-axis magnetic-pole regions 12 in the circumferential direction and that of each of the teeth 9 therein.

The generation of the higher-order harmonics will be described hither in detail hereinafter. Specifically, as described above, the magnetic-pole densities on the first and second change regions 13 and 14 are assumed to be rapidly continuously changed between the magnetic-pole densities Bm on the magnetic-pole regions 11 and the magnetic-pole densities Bq on the q-axis magnetic-pole regions 12, respectively.

That is, every rotation of the rotor core 1 at the electric angle of 2π the period of which corresponds to the fundamental period whose inverse is the fundamental frequency, one of the teeth 9 faces a magnetic-pole region 11 with a predetermined magnetic polarity, an adjacent second change region 14, an adjacent q-axis magnetic-pole region 12 with a predetermined magnetic polarity, an adjacent first change region 13, a next magnetic-pole region 11 with a magnetic polarity reversed to the previous magnetic-pole region 11, a next second change region 14, a next q-axis magnetic-pole region 12 with a magnetic polarity reversed to the previous q-axis magnetic-pole region 12, a next first change region 13, and a next first magnetic-pole change region 11. This causes the magnetic fluxes of the one of the teeth 9 to be changed every cycle of the rotation of the rotor core 1 with the fundamental period corresponding to the electric angle of 2π.

The change of the magnetic fluxes of the one of the teeth 9 every cycle of the rotation of the rotor core 1 with the fundamental period causes the one of the teeth 9 to oscillate with the fundamental frequency, generating a magnetic wave. Because the waveform of the magnetic wave is not a sinusoidal waveform, the magnetic wave likely contains the higher-order harmonics.

Each of the teeth 9 therefore generates the magnetic wave containing the higher-order harmonics. Superposition of the higher-order harmonics caused by each of the teeth 9 likely corresponds to the magnetic noises created by the IPM motor M. Note that rotor core 1 partially oscillates in the radial directions, but because this rotor core's radial oscillation is substantially identical with that of each of the teeth 9, it can be ignored.

If the first change regions 13 each adjacent to one side of each magnetic-pole region 11 in the circumferential direction are arranged to be perfectly rotationally symmetrical with each other, the higher-order harmonics, which are created by each of the teeth 9 due to the passing of each of the first change regions 13 in front of each of the teeth 9, may have substantially the same phase and waveform as each other.

This may cause the superimposition of the higher-order harmonics to totally increase. Similarly, in the case where the second change regions 14 are arranged to be perfectly rotationally symmetrical with each other, the superimposition of the higher-order harmonics may increase. When the period for which the rotor core 1 has rotated by the electric angle of 2π is set to the fundamental period, the attractive force of each of the teeth 9 is generated based on the magnetic-poles of the adjacent magnets 3 whose magnetic polarities are reversed to each other.

Assuming that the number of teeth 9 is set to the number of permanent magnets (magnet poles) 3, the magnet noises, therefore, would mainly contain fundamental harmonics each with the half of the fundamental period and higher-order harmonics each with an integer submultiple of the fundamental period.

When the number of teeth 9 is an integer m multiple of the number of permanent magnets 3, therefore, the period of each of the fundamental harmonics is 2 m submultiple of the fundamental period. As described above, because the IPM motor M according to the first embodiment is a three-phase motor so that the stator core 100 has three teeth 9 per permanent magnet 3, the period of each of the fundamental harmonics is 6 submultiple of the fundamental period. In other words, because the fundamental frequency is the inverse of the fundamental period, the frequency of each of the fundamental harmonics is 6 multiple of the fundamental frequency. In other words, the 6-th order harmonics are contained in the magnetic noises,

In addition, even m a case of assuming at the stator core 100 (the teeth 9) is relatively rotated with respect to the rotor core 1, the principle of generation of the higher-order harmonics can be described similarly to the above descriptions.

For example, assuming that the teeth 9 are relatively rotated with respect to the rotor core 1, one of the teeth 9 has passed directly in front of one of the first and second change regions 13 and 14. In this state, the magnetic-pole density on the inner periphery of the one of the teeth 9 is rapidly changed from one of the magnetic-pole density Bm and the q-axis magnetic-pole density Bq to the other thereof.

The change of the magnetic-pole density on the inner periphery 90 of the one of the teeth 9 causes rapidly periodic change of magnetic attractive forces in the radial directions of the one of the teeth 9 between the outer periphery 10 of the rotor core 1 and the inner periphery 90 of any one of the teeth 9.

The rapidly periodic change of the magnetic attractive forces between the outer periphery 10 of the rotor core 1 and the inner periphery 90 of the one of the teeth 9 causes the one of the teeth 9 to vibrate (expand and contract) in the radial directions thereof at the fundamental frequency when an inertial mass of the one of the teeth 9 is ignored.

Specifically, assuming that a period for which the one of the teeth 9 has passed directory in front of the adjacent first and second change regions 13 and 14 is the fundamental period of the magnetic noises, the higher-order harmonics corresponding to the number of teeth 9 within the fundamental period, such as the 6-th order harmonics, are generated as the magnetic noises for each of the teeth 9.

In order to prevent the higher-order harmonics from increasing, the rotor core 1 of the IMP motor M according to the first embodiment is designed such that, when at least one of the circumferential positions P13 of the first change regions 13 is opposite to the circumferential position of one of the teeth 90, at least another one of the remaining circumferential positions P13 is not opposite to at least another one of the circumferential positions of the teeth 90.

In other words, in the rotor core 1, the distance between at least one of the circumferential positions P13 of the first change regions 13 and the circumferential position of one of the teeth 9, which is the closest thereto, is different from the distances between the remaining circumferential positions P13 of the first change regions 13 and the circumferential positions of some of the teeth 9, which are closest thereto.

That is, the rotor core 1 is configured such that at least one of the first change regions 13 each adjacent to one side of each magnetic-pole region 11 in the circumferential direction is arranged to be rotationally asymmetrical with the remaining first change regions 13.

Specifically, in the first embodiment, as illustrated in FIGS. 1 and 2, a circumferential interval between the circumferential positions P13, P13 of at least one pair of adjacent first change regions 13, 13 is different from the circumferential intervals between the circumferential positions P13, P13 of the remaining pairs of adjacent first change regions 13, 13.

In other words, in the first embodiment, as illustrated in FIGS. 1 and 2, the extending directions of the other ends 41a2 to 44a2 of the fist flux barriers 41 to 44 are different from each other. This allows circumferential intervals between the positions of the centers C of the respective adjacent other end portions 41a2 to 44a2 of the first flux barriers 41 to 44 to be different from each other.

In addition, the rotor core 1 is designed such that, when at least one of the circumferential positions P14 of the second change regions 14 is opposite to the circumferential position of one of the teeth 9, at least another one of the remaining circumferential positions P14 of the second change regions 14 is not opposite to at least another one of the circumferential positions of the teeth 9.

In other words, in the rotor core 1, the difference between at least one of the circumferential positions P14 of the second change regions 14 and the circumferential position of one of the teeth 9, which is the closest thereto, is different from the distances between the remaining circumferential positions P14 of the second change regions 14 and the circumferential positions of some of the teeth 9, which are closest thereto.

That is, the rotor core 1 is configured such that at least one of the second change regions 14 each adjacent to one side of each magnetic-pole region 11 in the circumferential direction is arranged to be rotationally asymmetrical with the remaining second change regions 14.

Specifically, in the first embodiment, as illustrated in FIGS. 1 and 2, a circumferential interval between the circumferential positions P14, P14 of at least one pair of adjacent second change regions 14, 14 is different from the circumferential intervals between the circumferential positions P14, P14 of the remaining pairs of adjacent second change regions 14, 14.

In other words, in the first embodiment, as illustrated in FIGS. 1 and 2, the extending directions of the other ends 51a2 to 54a2 of the second flux barriers 51 to 54 are different from each other. This allows circumferential intervals between the positions of the centers C of the respective adjacent other end portions 51a2 to 54a2 of the second flux barriers 51 to 54 to be different from each other.

Note that, in the first embodiment, the circumferential position P13 of each first change region 13 means a position thereon having a predetermined value of the magnetic-pole density. The predetermined value of the magnetic-pole density is the average of the absolute value of the magnetic-pole density Bm on each magnetic-pole region 11 adjacent to each first change region 13 and the absolute value of the q-axis magnetic-pole density Bq on each q-axis magnetic-pole region 12 adjacent to each first change region 13.

Similarly, in the first embodiment, the circumferential position P14 of each first change region 14 means a position thereon having a predetermined value of the magnetic-pole density. The predetermined value of the magnetic-pole density is the average of the absolute value of the magnetic-pole density Bm on each magnetic-pole region 11 adjacent to each second change region 14 and the absolute value of the q-axis magnetic-pole density 13q on each q-axis magnetic-pole region 12 adjacent to each second change region 14.

Moreover, in the fist embodiment, the circumferential position of each of the teeth 9 means a center position of the inner periphery of each of the teeth 9 in the circumferential direction.

Because the circumferential positions P13 of the first change regions 13 are arranged to be rotationally asymmetrical with each other, the phases of the higher-order harmonics generated from each of the teeth 9 facing each of the first change regions 13 are shifted to each other. This allows the superimposition of the higher-order harmonics to decrease, as compared with the case where the first change regions 13 are arranged to be perfectly rotationally symmetrical with each other.

Similarly, when the circumferential positions P14 of the second change regions 14 are arranged to be rotationally asymmetrical with each other, the phases of the higher-order harmonics generated from each of the teeth 9 facing each of the second change regions 14 are shifted to each other. This allows the superimposition of the higher-order harmonics to decrease, as compared with the case where the second change regions 14 are arranged to be perfectly rotationally symmetrical with each other.

Specifically, in the first embodiment, the circumferential positions P13 and P14 of the first and second change regions 13 and 14 are arranged to be rotational asymmetrical with each other. This allows the phases of the higher-order harmonics of the radial vibration forces of the teeth 9 to be asynchronous with each other, thereby reducing the sum of the magnet noises generated from the teeth 9.

The structures and arrangements of the remaining first flux barriers 4 provided in the remaining half circular portion of the rotor core 1, which are not shown in FIG. 1, are rotationally symmetrical with respect to those of the first flux barriers 41 to 44 through 180 degrees. Similarly, the structures and arrangements of the remaining second flux barriers 5 provided in the remaining half circular portion of the rotor core 1, which are not shown in FIG. 1, are rotationally symmetrical with respect to the second flux barriers 51 to 54 through 180 degrees.

As described above, the amount of fluxes through one of the teeth 9 in the radial directions thereof, or that of fluxes connecting between the one of the teeth 9 and the outer periphery 10 of the rotor core 1 are rapidly changed when one of the first and second change regions 13 and 14 has passed directly in front of the one of the teeth 9. The rapid change of the amount of fluxes through the one of the teeth 9 in the radial directions thereof causes the radially magnetic attractive forces between the inner periphery of the one of the teeth 9 and the outer periphery 10 of the rotor core 1 to be rapidly changed.

In the first embodiment, however, it is possible to gradually shift the rapid change timings of the magnetic attractive forces between the inner periphery of each of the teeth 9 and the outer periphery 10 of the rotor core 1. This allows the higher-order harmonics in the magnetic noises to decrease, as compared with conventional IMP motors.

As illustrated in FIG. 1, the three-phase stator windings are wound on the stator core 100, and the number of six (or an integer multiple of six) teeth 9 are provided to correspond to the rotation of the rotor core 1 by the electric angle of 2π. In the structure, one of the magnetic-pole regions 11 has passed directly in front of one of the teeth 9 every period of six submultiple of the fundamental frequency. When the fundamental frequency is assumed to the first-order frequency, the radial vibration forces (magnetic vibration forces) each with 6 multiple of the first-order frequency, such as the sixth-order harmonics of the radial vibration forces act on each of the teeth 9.

As set forth above, in the first embodiment of the present invention, however, the circumferential intervals between the respective adjacent circumferential positions P13 of the first change regions 13 are different from each other, and the respective adjacent circumferential positions P14 of the second change regions 14 are different from each other. This structure of the first embodiment allows the phases of the harmonics of the order 6 and an integer multiple thereof of the radial vibration forces to be shifted on each of the first and second change regions 13 and 14. As a result, the harmonics of the order 6, 12, 18, 24, . . . of the radial vibration forces are reduced.

### First Modification

A first modification of the first embodiment of the present invention will be described hereinafter.

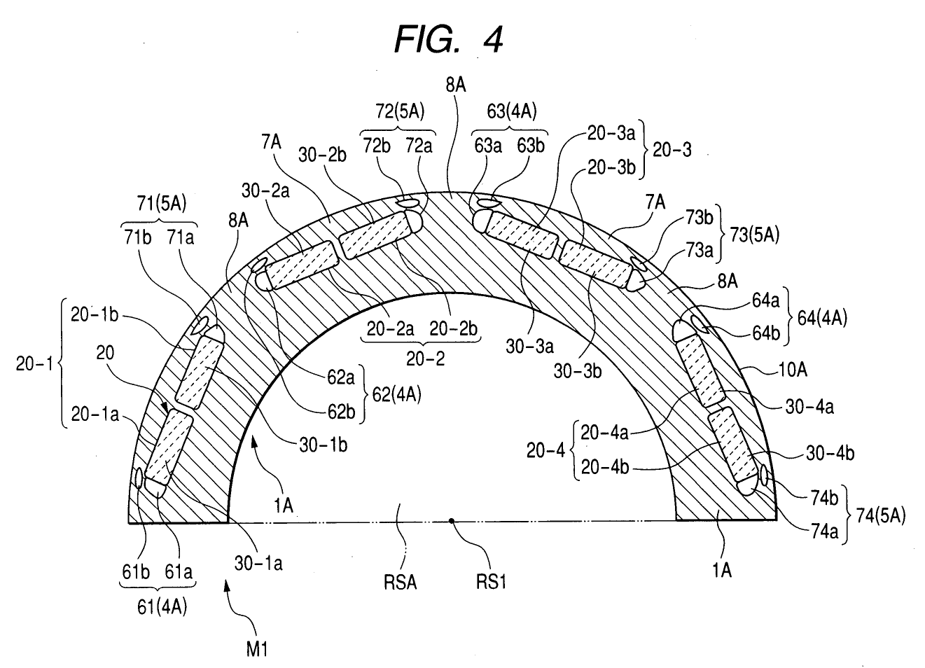

FIG. 4 schematically illustrates the structure of the half of an IPM motor M1 according to the first modification of the first embodiment of the present invention.

Specifically, the IPM motor M1 is provided with a rotor core 1A with soft magnetism and an annular shape in its lateral cross section. The rotor core 1A is made of, for example, a laminated-electromagnetic steel plate and fixedly fitted around the outer periphery of a rotating shaft RSA.

The rotor core 1A is provided with a plurality of magnet retaining slit portions 20. The slit portions 20 correspond to the magnet retaining slits 2, respectively.

Specifically, the slit portions 20 has a pair of slits 20-1a and 20-1b penetrated through the rotor core 1A with a predetermined circumferential interval therebetween to parallely extend along the axial direction of the rotor core 1A, respectively. Similarly, the slit portion 20 has a pair of slits 20-2a and 20-2b penetrated through the rotor core 1A with a predetermined circumferential interval therebetween to parallely extend along the axial direction of the rotor core 1A, respectively. The slit portion 20 has a pair of slits 20-3a and 20-3b penetrated through the rotor core 1A with a predetermined circumferential interval therebetween to parallely extend along the axial direction of the rotor core 1A, respectively. The slit portion 20 has a pair of slits 20-4aand 20-4b penetrated through the rotor core 1A with a predetermined circumferential interval therebetween to parallely extend along the axial direction of the rotor core 1A, respectively.

The shape and arrangement of each of the slit portions 20-1 to 20-4 are substantially the same as each of the slits 2-1 to 2-4 according to the first embodiment except that each of the slit portions 20-1 to 20-4 has the predetermined circumferential interval so that the slit portions 20-1 to 20-4 are separated into the slits 20-1a and 20-1b to 20-4aand 20-4b, respectively. Specifically, one lateral end portion of each of the slit portions 20-1a to 20-4a is opposite to one lateral end portion of each of the slit portions 20-1b to 20-4b with the corresponding predetermined circumferential interval. The predetermined intervals allow supporting the strength of the rotor core 1A.

Moreover, the rotor core 1A is provided with a plurality of plate-like permanent magnet members 30 (30-1 to 30-4). Each of the permanent magnet members 30 is provided with a pair of permanent magnets 30-1a and 30-1b to 30-4a and 30-4b. Each of the permanent magnets 30-1a and 30-1b to 30-4aand 30-4b has substantially the same shape as the inner space of each of the slits 20-1a and 20-1b to 20-4a and 20-4b.

The permanent magnet members 30-1 to 30-4 correspond to the permanent magnets 3-1 to 3-4 according to the fist embodiment, respectively, except that the permanent magnet members 30-1 to 30-4 are separated into the permanent magnets 30-1a and 30-1b to 30-4a to 30-4b, respectively.

Specifically, the permanent magnets 30-1a and 30-1b are inserted to be fitted in the slits 20-1a and 20-1b, respectively. Similarly, the permanent magnets 30-2a and 30-2b to 30-4a and 30-4b are inserted to be fitted in the slits 20-2a and 20-2b to 20-4a and 20-4b, respectively.

Preferably, the principle planes of each of the permanent magnet members 30-1 to 30-4 are magnetized in their thickness directions to serve as magnetic poles with opposing magnetic polarities, such as N and S poles, respectively. The rotor core 1A is configured such that the N and S poles of the permanent magnet members 30-1 to 30-4 are alternately arranged in the circumferential direction like the permanent magnets 3-1 to 3-4 according to the first embodiment.

The rotor core 1A is provided with a plurality of first flux barriers 4A, and a plurality of second flux barriers 5A. Each of the first and second flux barriers 4A and 5A is penetrated through the rotor core 1 so as to parallely extend along the axial direction thereof. The flux barriers 4A and 5A work to prevent magnetic fluxes of the permanent magnet members 30 from being short-circuited to each other in the rotor core 1A without through the stator core (not shown).

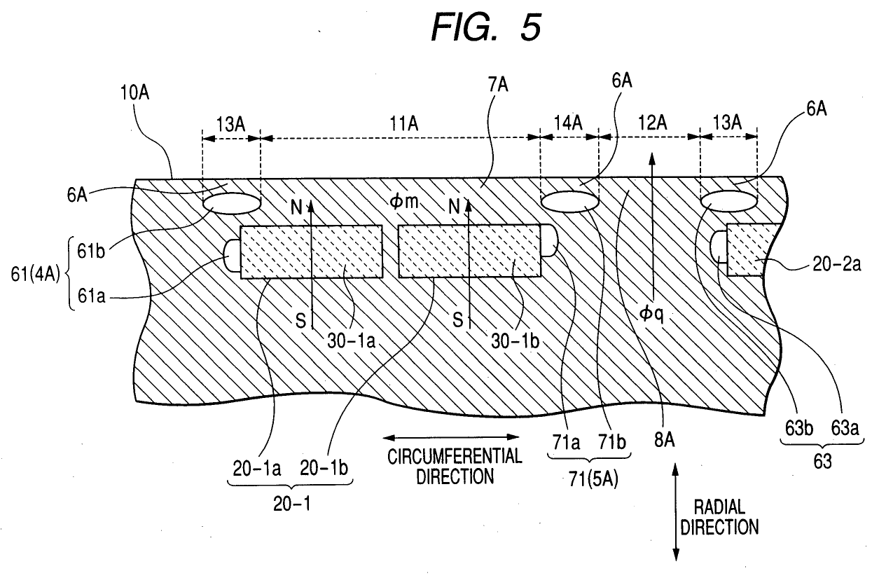

In FIGS. 4 and 5, first flux barriers 61 to 64 in all of first flux barriers 4A are illustrated, and second flux barriers 71 to 74 in all of the second flux barriers 5A are illustrated therein.

The first flux barriers 61 to 64 are provided with pairs of first flux barrier elements 61a and 61b to 64a and 64b, respectively.

Each of the first flux barrier elements 61a to 64a are connected to be communicated with the other lateral end portion of each of the slits 20-1a to 20-4a.

The first flux barrier elements 61b to 64b are substantially radially arranged with respect to the first flux barrier elements 61a to 64a with predetermined intervals, respectively. In addition, the first flux barrier elements 61b to 64b arc substantially concentrically arranged apart from the outer periphery 10A of the rotor core 1A at regular spaces, respectively.

The second flux barriers 71 to 74 are provided with pairs of second flux barrier elements 71a and 71b to 74a and 74b, respectively.

Each of the second flux barrier elements 71a to 74a are connected to be communicated with the other lateral end portion of each of the slits 20-1b to 20-4b.

The second flux barrier elements 71b to 74b are substantially radially arranged with respect to the second flux barrier elements 71a to 74a with predetermined intervals, respectively. In addition, the second flux barrier elements 71b to 74b are substantially concentrically arranged apart from the outer periphery 10A of the rotor core 1A at regular spaces, respectively.

The rotor core 1A is provided with a plurality of thin-walled portions 6A formed between the outer periphery 10A of the rotor core 1A and the first flux barrier elements 61b to 64b and the second flux barrier elements 71b to 74b, respectively.

Specifically, as illustrated in FIGS. 4 and 5, the circumferential width of the thin-walled portion 6A between the first flux barrier element 61b and the opposing outer periphery 10A of the rotor core 1A corresponds to the circumferential width of the first flux barrier element 61b.

Similarly, the circumferential widths of the thin-walled portions 6A between the first flux barrier elements 62b to 64b and the opposing outer periphery 10A of the rotor core 1A correspond to the circumferential widths of the first flux barrier element 62b to 64b, respectively.

Like the first flux barriers 4A, the widths of the tin-walled portions 6A between the second flux barrier elements 72b to 74b and the opposing outer periphery 10A of the rotor core 1A correspond to the circumferential widths of the second flux barrier element 72b to 74b, respectively.

Each of the first flux barrier elements 61b to 64b allows directions of magnetic fluxes flowing through each of the corresponding thin-walled portions 6A to be regulated in the circumferential direction Similarly, each of the second flux barrier elements 71b to 74b allows directions of magnetic fluxes flowing through each of the corresponding in-walled portions 6A to be regulated in the circumferential direction.

In addition, the rotor core 1A is provided with a plurality of q-axis flux paths (low magnetic resistance portions) 8A formed between the first flux barrier elements 4A and the second flux barrier elements 5A, respectively, which are similar to the first embodiment.

In addition, in the first modification of the first embodiment, the stator core (not shown) is provided with a plurality of slots arranged in the circumferential direction of the stator core with regular pitches. In addition, the stator core is provided with teeth formed between the slots, respectively. In the first modification, the number of slots (teeth) is twelve times of the number of permanent magnet members 30.

As illustrated in FIGS. 4 and 5, the rotor core 1A is provided with a plurality of magnet adjacent portions 7A arranged between the permanent magnet members 30 and the outer periphery 10A of the rotor core 1A, respectively. Each of the plurality of magnet adjacent portions 7A is also arranged between both the thin-wall portions 6A adjacent thereto.

As well as the first embodiment, as illustrated in FIG. 5, the outer periphery 10A of the rotor core 1A has a plurality of magnetic-pole regions 11A, which correspond to the outer surfaces of the magnet adjacent portions 7A to be arranged radially closely outside of the permanent magnet elements 30, respectively.

The outer periphery 10A of the rotor core 1A also has a plurality of q-axis magnetic-pole regions 12A arranged radially closely outside of the low magnetic resistance portions 8A, respectively.

As illustrated in FIG. 5, the outer periphery 10A of the rotor core 1A has a plurality of first magnetic-pole density change regions 13A corresponding to the outer peripheral surfaces of the thin-wall portions 6A adjacent to the first flux barrier elements 61b to 64b, respectively. Similarly, the outer periphery 10A of the rotor core 1A has a plurality of second magnetic-pole density change regions 14A corresponding to the outer peripheral surfaces of the thin-wall portions 6A adjacent to the second flux barrier elements 71b to 74b, respectively.

Like the first embodiment, in order to prevent the higher-order harmonics from increasing, the rotor core 1A is configured such that, when at least one of the circumferential positions P13 of the first change regions 13A is opposite to the circumferential position of one of the teeth 9, at least another one of the remaining circumferential positions P13 of the first change regions 13A is not opposite to at least another one of the circumferential positions of the teeth 9.

Specifically, the rotor core 1A is configured such that at least one of the first change regions 13A each adjacent to one side of each magnetic-pole region 11A in the circumferential direction is arranged to be rotationally asymmetrical with the remaining first change regions 13A.

In addition, the rotor core 1A is configured such that, when at least one of the circumferential positions P14 of the second change regions 14A is opposite to the circumferential position of one of the teeth 9, at least another one of the remaining circumferential positions P14 of the second change regions 14A is not opposite to at least another one of the circumferential positions of the teeth 9.

Specifically, the rotor core 1A is configured such that at least one of the second change regions 14A each adjacent to one side of each ma genetic-pole region 11A in the circumferential direction is arranged to be rotationally asymmetrical with the remaining second change regions 14A.

As set forth above, in the first modification, the circumferential positions P13 and P14 of the first and second change regions 13A and 14A are arranged to be rotationally asymmetrical with each other. This allows the phases of the higher-order harmonics of the radial vibration forces of the teeth (not shown) to be asynchronous with each other, thereby reducing the sum of the magnet noises generated from the teeth.

### Second Modification

A second modification of the first embodiment of the present invention will be described hereinafter.

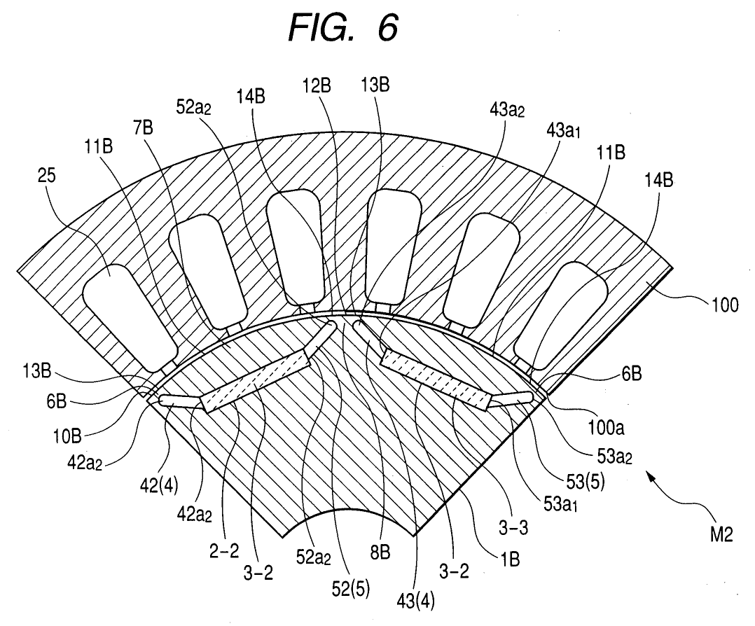

FIG. 6 schematically illustrates the structure of the quarter of an IPM motor M2 according to the second modification of the first embodiment of the present invention.

In the second modification, the rotor core M according to the first embodiment has been divided into, for example, four rotor core elements. Each of the four-divided rotor core elements has a substantially quarter sector in its lateral cross section. FIG. 6 illustrates only one rotor core element 1B.

Like the first embodiment, the rotor core element 1B is provided with the slits 2-2 and 3-2, and the permanent magnets 3-2 and 3-3 inserted to be fitted thereinto, respectively. The rotor core element 1B is also provided with the first flux barriers 4 and second flux barriers 5.

As illustrated in FIG. 6, one end 42a1 of the first flux barrier 42 is connected to be communicated with the first lateral end portion 2a3 of the slit 2-2, and the other end 42a2 of the first flux barrier 42 extends obliquely outwardly close to the outer periphery 10B of the rotor core element 1B.

One end 52a1 of the second flux barrier 52 is connected to be communicated with the second lateral end portion 2a4 of the slit 2-2, and the other end 52a2 of the second flux barrier 52 extends obliquely close to the outer periphery 10B of the rotor core element 1B.

As illustrated in FIG. 6, the rotor core element 1B is provided with thin-walled portions 6B formed between the outer periphery 10B of the rotor core element 1B and the other ends 42a2 to 43a2 and 52a2 to 53a2 of the first and second flux barriers 42 to 43 and 52 to 53 respectively.

The rotor core element 1B is also provided with magnet adjacent portions 7B arranged between the permanent magnets 3 and the outer periphery 10B of the rotor core 1B, respectively. Each of the plurality of magnet adjacent portions 7B is also arranged between both the thin-wall portions 6B adjacent thereto.

In addition, the rotor core element 1B is provided with a q-axis flux path (Row magnetic resistance portion) 8B formed between the first flux barrier element 43 and the second flux barrier element 52, which is similar to the first embodiment.

As well as the first embodiment, as illustrated in FIG. 6, the outer periphery 10B of the rotor core element 1B has magnetic-pole regions 11B, which correspond to the outer surfaces of the magnet adjacent portions 7B to be arranged radially closely outside of the permanent magnets 3, respectively.

The outer periphery 10B of the rotor core 1B also has a q-axis magnetic-pole region 12B arranged radially closely outside of the low magnetic resistance portion 8B.

As illustrated in FIG. 6, the outer periphery 10B of the rotor core element 1B has first magnetic-pole density change regions 13B corresponding to the outer peripheral surfaces of the thin-wall portions 6B adjacent to the other ends 42a2 and 43a2 of the first flux barriers 42 and 43, respectively. Similarly, the outer periphery 10B of the rotor core element 1B has second magnetic-pole density change regions 14B corresponding to the outer peripheral surfaces of the thin-wall portions 6B adjacent to the other ends 52a2 and 53a2 of the second flux barriers 52 and 53, respectively.

In the second modification, in order to prevent the higher-order harmonics from increasing, the rotor core element 1B is configured such that, when at least one of the circumferential positions P13 of the first change regions 13B is opposite to the circumferential position of one of the teeth 9, at least another one of the remaining circumferential positions P13 of the first change regions 13B is not opposite to at least another one of the circumferential positions of the teeth 9.

Specifically, in the rotor core of the IMP motor M2, at least one of the first change regions 13B each adjacent to one side of each magnetic-pole region 11B in the circumferential direction is arranged to be rotationally asymmetrical with the remaining first change regions 13B.

In addition, the rotor core element 1B is designed such that, when at least one of the circumferential positions P14 of the second change regions 14B is opposite to the circumferential position of one of the teeth 9, at least another one of the remaining circumferential positions P14 of the second change regions 14B is not opposite to at least another one of the circumferential positions of the teeth 9.

Specifically, in the rotor core of the IMP motor M2, at least one of the second change regions 14B each adjacent to one side of each magnetic-pole region 11B in the circumferential direction is arranged to be rotationally asymmetrical with the remaining second change regions 14B.

For example, the structures and arrangements of the remaining first flux barriers provided in the remaining three-quarter rotor core elements, which are not shown in FIG. 6, are rotationally symmetrical with respect to those of the first flux barriers 42 and 43 through 45 degrees, 90 degrees, and 135 degrees, respectively. Similarly, the structures and arrangements of the remaining second flux barriers 52 and 53 provided in the remaining three-quarter rotor core elements, which are not shown in FIG. 6, are rotationally symmetrical with respect to those of the second flux barriers 52 and 53 through 45 degrees, 90 degrees, and 135 degrees, respectively.

Like the first embodiment, in the second modification, the circumferential positions P13 and P14 of the first and second change regions 13B and 14B are arranged to be rotationally asymmetrical with each other. This allows the phases of the higher-order harmonics of the radial vibration forces of the teeth 25 to be asynchronous with each other, thereby reducing the sum of the magnet noises generated from the teeth 25.

### Third Modification

A third modification of the first embodiment of the present invention will be described hereinafter.

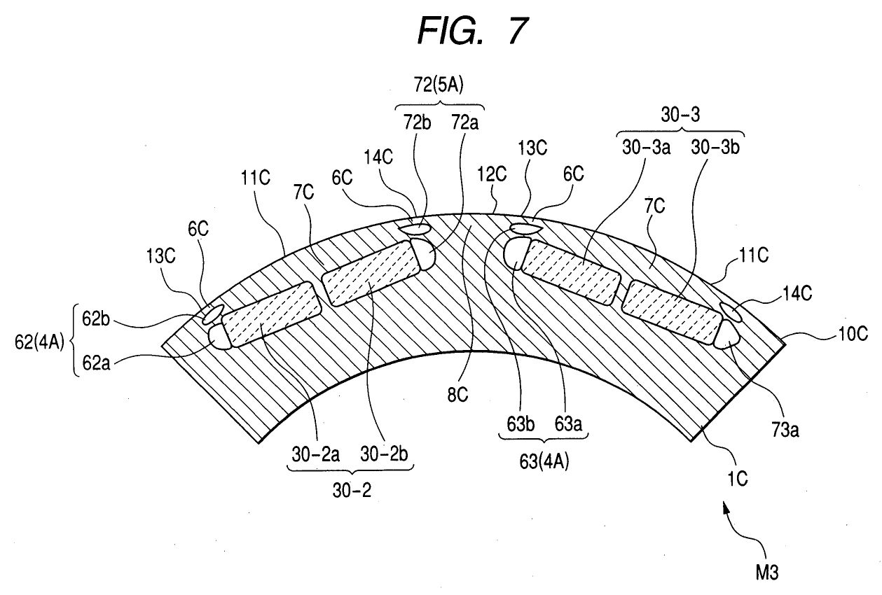

FIG. 7 schematically illustrates the structure of the quarter of an IPM motor M3 according to the third modification of the first embodiment of the present invention.

In the third modification, the rotor core M1 according to the first modification has been divided into, for example, four rotor core elements. Each of the four-divided rotor core elements has a substantially quarter sector in its lateral cross section. FIG. 7 illustrates only one rotor core element 1C.

Like the first modification, the rotor core element 1C is provided with the slit portions 20-2 consisting of the pair of slits 20-2a and 20-2b and with the slit portions 20-3 consisting of the pair of slits 20-3a and 20-3b. The rotor core element 1C is also provided with the permanent magnet members 30-2 consisting of the permanent magnets 30-2a and 30-2b and with the permanent magnet members 30-3 consisting of the permanent magnets 30-3a and 30-3b. The permanent magnets 30-2a and 30-2b are inserted to be fitted in the slits 20-2a and 20-2b, respectively. Similarly, the permanent magnets 30-3a and 30-3b are inserted to be fitted in the slits 20-3a and 20-3b, respectively.

The rotor core element 1C is provided with the first flux barriers 62 and 63 and the second flux barriers 72 and 73.

As illustrated in FIG. 7, each of the first flux barrier elements 62a and 63a are connected to be communicated with the other lateral end portion of each of the slits 20-2a to 20-3a.

The first flux barrier elements 62b and 63b are substantially concentrically arranged apart from the outer periphery 10C of the rotor core 1C at regular spaces, respectively.

Each of the second flux barrier elements 72a and 73a are connected to be communicated with the other lateral end portion of each of the slits 20-2b to 20-3b.

Each of the second flux barrier elements 72b and 73b are substantially concentrically arranged apart from the outer periphery 10C of the rotor core 1C at regular spaces, respectively.

As illustrated in FIG. 7, each of the first flux barrier elements 62b to 63b and the second flux barrier elements 72b to 73b are arranged in the circumferential direction.

As illustrated in FIG. 7, the rotor core element 1C is provided with thin-walled portions 6C formed between the outer periphery 10C of the rotor core element 1C and the first and second flux barrier elements 62b to 63b and 72b and 73b, respectively.

The rotor core element 1C is also provided with magnet adjacent portions 7C arranged between the permanent magnets elements 30 and the outer periphery 10C of the rotor core 1C, respectively. Each of the plurality of magnet adjacent portions 7C is also arranged between both the thin-wall portions 6C adjacent thereto.

In addition, the rotor core element 1C is provided with a q-axis flux path (low magnetic resistance portion) 8C formed between the first flux barrier element 63b and the second flux barrier element 72b, which is similar to the first modification.

As well as the first modification, as illustrated in FIG. 7, the outer periphery 10C of the rotor core element 1C has magnetic-pole regions 11C, which correspond to the outer surfaces of the magnet adjacent portions 7C to be arranged radially closely outside of the permanent magnets 30, respectively.

The outer periphery 10C of the rotor core 1C also has a q-axis magnetic-pole region 12C arranged radially closely outside of the low magnetic resistance portion 8C.

As illustrated in FIG. 7 the outer periphery 10C of the rotor core element 1C has first magnetic-pole density change regions 13C corresponding to the outer peripheral surfaces of the thin-wall portions 6C adjacent to the first flux barrier elements 62b and 63b, respectively.

Similarly, the outer periphery 10C of the rotor core 1C has second magnetic-pole density change regions 14C corresponding to the outer peripheral surfaces of the thin-wall portions 6C adjacent to the second flux barrier elements 72b and 73b, respectively.

In the third modification, in order to prevent the higher-order harmonics from increasing, the rotor core of the IMP motor M3 is configured such that, when at least one of the circumferential positions P13 of the first change regions 13C is opposite to the circumferential position of one of the teeth 9, at least another one of the remaining circumferential positions P13 of the first change regions 13C is not opposite to at least another one of the circumferential positions of the teeth 9.

Specifically, in the rotor core of the IMP motor M3, at least one of the first change regions 13C each adjacent to one side of each magnetic-pole region 11C in the circumferential direction is arranged to be rotationally asymmetrical with the remaining first change regions 13C.

The rotor core element 1C is designed such that, when at least one of the circumferential positions P14 of the second change regions 14C is opposite to the circumferential position of one of the teeth 9, at least another one of the remaining circumferential positions P14 of the second change regions 14C is not opposite to at least another one of the circumferential positions of the teeth 9.

Specifically, in the rotor core of the IMP motor M3, at least one of the second change regions 14C each adjacent to one side of each magnetic-pole region 11C in the circumferential direction is arranged to be rotationally asymmetrical with the remaining second change regions 14C.

The structures and arrangements of the remaining first flux barriers provided in the remaining three-quarter rotor core elements, which are not shown in FIG. 7, are rotationally symmetrical with respect to those of the first flux barriers 62 and 63 through 45 degrees, 90 degrees, and 135 degrees, respectively. Similarly, the structures and arrangements of the remaining second flux barriers provided in the remaining three-quarter rotor core elements, which are not shown in FIG. 6, are rotationally symmetrical with respect to those of the second flux barriers 72 and 73 through 45 degrees, 90 degrees, and 135 degrees, respectively.

Like the first embodiment, in the third modification, the circumferential positions P13 and P14 of the first and second change regions 13C and 14C are arranged to be rotational asymmetrical with each other. This allows the phases of the higher-order harmonics of the radial vibration forces of the teeth 25 to be asynchronous with each other, thereby reducing the sum of the magnet noises generated from the teeth 25.

In the second and third modifications, the rotor cores are divided into a plurality of rotor core elements. The scope of the division of the rotor cores is to:

divide the first change regions into a plurality of groups; and

align, when at least one of the circumferential positions P13 of the first change regions 13 in one of the groups is opposite to the circumferential position of one of the teeth 9, the circumferential positions P13 in the other of the groups with some of the circumferential positions of the teeth 9, respectively. In addition, the scope of the division of the rotor cores is, when at least one of the circumferential positions P13 of the first change regions 13 in one of the groups is opposite to the circumferential position of one of the teeth 9, to disalign the remaining circumferential positions P13 of the first change regions 13 in one of the groups with any circumferential positions of the teeth 9.

Specifically, in each of the second and third modifications, division of the rotor core is used as means to divide the first change regions into a plurality of groups. It is preferable, therefore to divide the rotor core with respect to each predetermined angle to divide the rotor core. In each of the second and third modifications, the rotor core is divided with respect to the angle of 90 degrees to separate the first change regions into four groups, but the rotor core can be divided with respect to a predetermined angle to separate the first change regions into some groups. For example, the rotor core can be divided with respect to 180 degrees to separate the first change regions into two groups. These descriptions can be established in cases of dividing the second change regions 14 into a plurality of groups.

In the first embodiment and the first to third modifications, it is preferable that, when the circumferential position of one of the paired first change regions 13, 13, which are circumferentially adjacent to each other, is opposite to the circumferential position of one of the teeth 9, the other of the paired first change regions 13, 13 is out of alignment with another one of the circumferential positions of the teeth 9 by the half of a slot pitch of the stator core. This allows the higher-order harmonics having a period corresponding to the slot pitch to effectively decrease.

Similarly, it is preferable that, when the circumferential position of one of the paired second change regions 14, 14, which are circumferentially adjacent to each other, is opposite to the circumferential position of one of the teeth 9, the other of the paired second change regions 14, 14 is out of alignment with another one of the circumferential positions of the teeth 9 by the half of the slot pitch. This allows the higher-order harmonics having the period corresponding to the slot pitch to effectively decrease. It is a matter of course that the circumferential disagreement between the paired adjacent first change regions 13, 13 and that between the paired adjacent second change regions 14, 14 are not limited to the half of the slot pitch, respectively.

In addition, in the first embodiment and the first to third modifications, the rotor core 1 (1A to 1C) is configured such that when at least one of the circumferential positions P13 of the first change regions 13 (13A to 13C) is opposite to the circumferential position of one of the teeth 9, at least another one of the remaining circumferential positions P13 is not opposite to at least another one of the circumferential positions of the teeth 9. In the present invention, the rotor core 1 (1A to 1C) is configured such that, when at least one of the circumferential positions P13 of the first change regions 13 (13A to 13C) is opposite to the circumferential position of one of the teeth 9, all of the remaining circumferential positions P13 are not opposite to any circumferential positions of the teeth 9.

Similarly, the rotor core 1 (1A to 1C) is configured such that, when at least one of the circumferential positions P14 of the second change regions 14 (14A to 14C) is opposite to the circumferential position of one of the teeth 9, all of the remaining circumferential positions P14 are not opposite to any circumferential positions of the teeth 9.

It is preferable that the circumferential widths of the low magnetic resistance portions 8 are substantially constant to minimize variation of the amount of q-axis fluxes radially passing through the low magnetic resistance portions 8. Specifically, the circumferential widths between the other ends 41a2 to 44a2 of the first flux barriers 41 to 44 and the other ends 51a2 to 54a2 of the second flux barriers 51 to 54 can be adjusted in addition to the adjustment of the extending directions of the other ends 41a2 to 44a2 of the first flux barriers 41 to 44 and the other ends 51a2 to 54a2 of the second flux barriers 51 to 54.

For example, when one of the circumferentially adjacent first change regions 13, 13 is arranged to be shifted to a first position against the direction of rotation of the rotor core 1, the other thereof can be arranged to be shifted to a second position along the detection of rotation of the rotor core 1; the first and second positions of the circumferentially adjacent first change regions 13, 13 are determined such that, when one of the circumferentially adjacent first change regions 13, 13 is located at the first position to be opposite to the circumferential position of one of the teeth 9, the other thereof is located at the second position to be opposite to another one of the circumferential positions of the teeth 9.

This allows the total circumferential width of the low magnetic resistance portions 8 to be kept substantially constant, preventing q-axis torque from decreasing.

When each of the circumferential widths of the q-axis magnetic-pole regions 12 is shorter than the circumferential width of each of the teeth, the pairs of first and second change regions 13 and 14 both circumferentially adjacent to each of the q-axis magnetic-pole regions 12 are assumed to sets of magnetic-pole density change regions, respectively.

In this case, it is possible to assume that, when at least one of the circumferential positions of the sets of magnetic-pole density change regions is opposite to the circumferential position of one of the teeth 9, at least another one of the circumferential positions of the remaining sets is not opposite to at least another one of the circumferential positions of the teeth 9.

### Second Embodiment

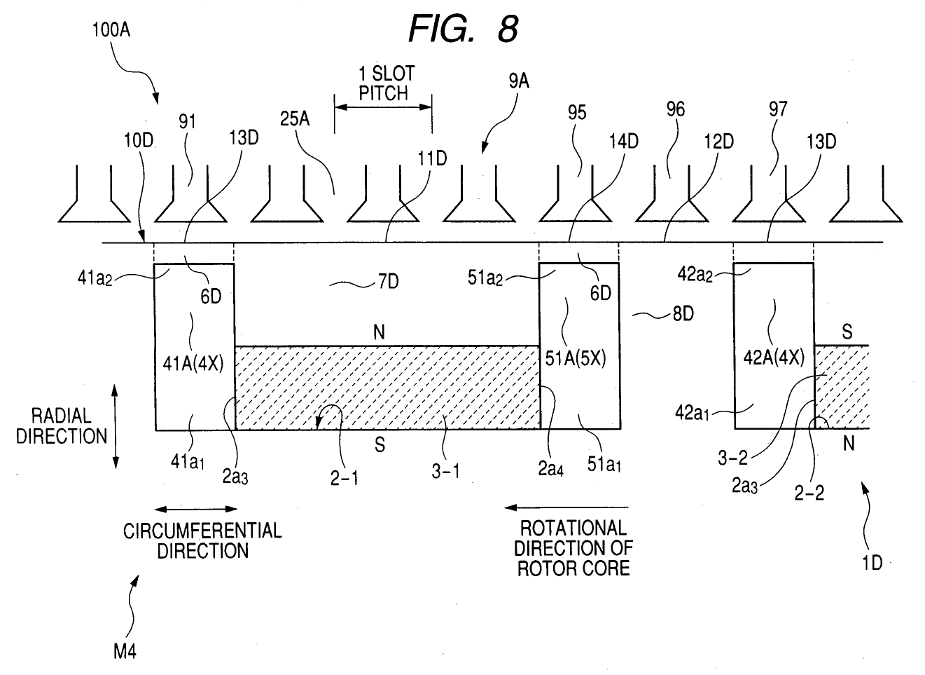

FIG. 8 is an enlarged cross sectional view schematically illustrating part of a peripheral portion of a rotor core 1D of an IPM motor M4 according to a second embodiment of the invention; this part is schematically developed in the circumferential direction of the rotor core 1D.

Like the first embodiment, the rotor core element 1D is provided with the slits 2 (2-1, 2-2, . . . ) and the permanent magnets 3 (3-1, 3-2, . . . ) inserted to be fitted thereinto, respectively. The rotor core element 1D is also provided with the first flux barriers 4X (41A, 42A, . . . ) and the second flux barriers 5X (51A, . . . ).

As illustrated in FIG. 8, one end 41a1 of the first flux barrier 41A in the first flux barriers 4X is connected to be communicated with the first lateral end portion 2a3 of the slit 2-1, and the other end 41a2 of the first flux barrier 41 radially outwardly extends close to the outer periphery 10D of the rotor core 1D. Similarly, one end 42a1 of the first flux barrier 42A in the first flux barriers 4X is connected to be communicated with the first lateral end portion 2a3 of the slit 2-2, and the other end 42a2 of the first flux barrier 42 radially outwardly extends close to the outer periphery 10D of the rotor core 1D. Each of the other first flux barriers (not shown) has the same structure as each of the first flux barriers 41A and 42A.

One end 51a1 of the second flux barrier 51A in the second flux barriers 5X is connected to be communicated with the second lateral end portion 2a4 of the slit 2-1, and the other end 51a2 of the second flux barrier 51A radially outwardly extends close to the outer periphery 10D of the rotor core 1D. Each of the other second flux barriers (not shown) has the same structure as the second flux barrier 51A.

As illustrated in FIG. 8, the rotor core 1D is provided with thin-walled portions 6D formed between the outer periphery 10D of the rotor core 1D and the other ends 41a2, 42a2, and 512a2) of the first and second flux barriers 41A, 42A, and 51A, respectively.

The rotor core 1D is also provided with magnet adjacent portions 7D arranged between the permanent magnets 3 (3-1, 3-2) and the outer periphery 10D of the rotor core 1D, respectively. Each of the plurality of magnet adjacent portions 7DB is also arranged between both the thin-wall portions 6D adjacent thereto.

In addition, the rotor core 1D is provided with a q-axis flux path (low magnetic resistance portion) 8D formed between the first flux barrier 42A and the second flux barrier 51A, which is similar to the first embodiment.

As well as the first embodiment, as illustrated in FIG. 8, the outer periphery 10D of the rotor core 1D has magnetic-pole regions 11D, which correspond to the outer surfaces of the magnet adjacent portions 7D to be arranged radially closely outside of the permanent magnets 3, respectively.

The outer periphery 10D of the rotor core 1D also has a q-axis magnetic-pole region 12D arranged radially closely outside of the low magnetic resistance portion 8D.

As illustrated in FIG. 8, the outer periphery 10D of the rotor core 1D has first magnetic-pole density change regions 13D corresponding to the outer peripheral surfaces of the thin-wall portions 6D adjacent to the other ends (41a2 and 42a2) of the first flux barriers 4X (41A and 42A), respectively. Similarly, the outer periphery 10D of the rotor core 1D has second magnetic-pole density change regions 14D corresponding to the outer peripheral surfaces of the thin-wall portions 6D adjacent to the other ends (including the other end 51a2) of the second flux barriers 5X (51A), respectively.

On the other hand, in the second embodiment, as shown in FIG. 8, like the first embodiment, a stator core 100A is disposed around the outer periphery 10D of the rotor core 1D such that the inner periphery of the stator core 100A is opposite to the outer periphery 10D of the rotor core 1D with a predetermined air gap.

As illustrated in FIG. 8, the stator core 100A is provided with a plurality of slots 25A penetrated therethrough so as to parallely extend along the axial direction of the rotor core 1D. The slots 25D are arranged in the circumferential direction of the stator core 100D with regular pitches. Specifically, the slots 25A provide a plurality of teeth 9A therebetween. Like the first embodiment, three-phase stator windings (not shown) each is separately wound on the stator core 100A.

The number of six teeth 9A are provided to correspond to the rotation of the rotor core 1D by the electric angle of π corresponding to one magnetic-pole pitch. Specifically, the number of two teeth 9A are provided for each phase and each magnetic-pole.

In the second embodiment, as clearly illustrated in FIG. 8, the IPM motor M4 is configured such that, when the circumferential position of at least one of the first change regions 13D is aligned with the circumferential position of one of the teeth 9A, the circumferential position of at least one of the second change regions 14D adjacent to the at least one of the first change regions 13D through the magnetic-pole region 11D is aligned with the circumferential position of another one of the teeth 9A.

Specifically, in FIG. 8, when the circumferential position of the first change region 13D corresponding to the first flux barrier 41A is aligned with the circumferential position of a tooth 91 in the teeth 9A, the circumferential position of the second change region 14D corresponding to the second flux barrier 51A is aligned with the circumferential position of a tooth 95 in the teeth 9A;

This structure allows, when the circumferential position of the first change region 13D corresponding to the first flux barrier 42A is aligned with the circumferential position of a tooth 97 in the teeth 9A, the circumferential position of the second change region 14D adjacent to the first change region 13D through the q-axis magnetic-pole region 12D to be aligned with the circumferential position of the tooth 95 in the teeth 9A. In FIG. 8, tooth 96 adjacent to both the teeth 95 and 97 is arranged to face the q-axis magnetic-pole region 12D.

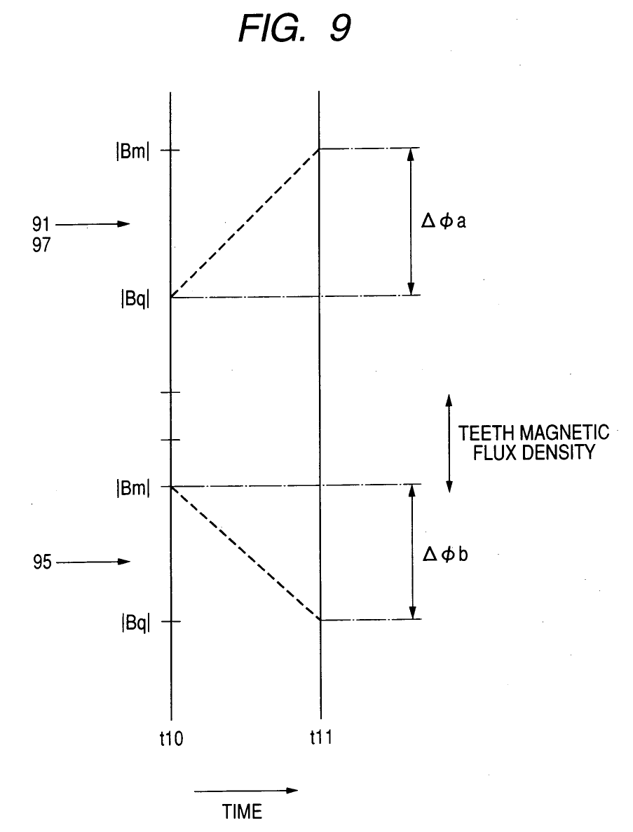

Change of magnetic flux densities (magnetic fluxes) on (through) the inner peripheries of the teeth 91, 95, and 97 is illustrated in FIG. 9.

As shown in FIG. 9, at time t10, the inner peripheries of the teeth 91 and 97 face the q-axis magnetic-pole regions 12D to have magnetic flux densities Bq, respectively. At time t10, the inner periphery of the tooth 95 faces the magnetic-pole region 11D to have magnetic flux density Bm.

While the rotor core 1D is rotated along the rotational direction shown in FIG. 8, rate of facing of the inner peripheries of the teeth 91 and 97 with the first change regions 13D is being increased so that each of the magnetic flux densities on the inner peripheries of the teeth 91 and 97 is being turned from the magnetic flux density Bq to the magnetic flux density Bm.

In contrast, dug rotation of the rotor core 1D along the rotational direction shown in FIG. 8, rate of facing of the tooth 95 with the second change region 14D is being increased so that the magnetic flux density on the inner periphery of the tooth 95 is being turned from the magnetic flux density Bm to the magnetic flux density Bq.

As a result, at time t11, the teeth 91 and 97 face the magnetic-pole regions 11D to have magnetic the flux densities Bm, respectively, and the tooth 95 faces the q-axis magnetic-pole region 12D to have the magnetic flux density Bq. Specifically, as illustrated in FIG. 9, the change A ΔΦa of magnetic fluxes is subjected to each of the teeth 91 and 97 during the time interval of (t11-t10), and the change ΔΦb of magnetic fluxes is subjected to the teeth 95 during the time interval of (t11-t10).

Note that the change of each of the magnetic flux densities on each of the inner peripheries of the teeth 91 and 97 and that of the magnetic flux density on the inner periphery of the tooth 95 are revered to each other. The absolute value of the amount of change of each of the magnetic flux densities on each of the inner peripheries of the teeth 91 and 97 is, however, substantially the same as that of the amount of change of the magnetic flux density on the inner periphery of the tooth 95.

In other words, the change ΔΦa of each of the magnetic fluxes through each of the inner peripheries of the teeth 91 and 97 and that (ΔΦb) of the magnetic fluxes through the inner periphery of the tooth 95 are revered to each other. The absolute value of the amount of change ΔΦa of each of the magnetic fluxes through each of the inner peripheries of the teeth 91 and 97 is, however, substantially the same as that of the amount change of ΔΦb of the magnetic flux density through the inner periphery of the tooth 95.

Specifically, the magnitude of the radial vibration force (magnetic vibration force) acting on each of the teeth 91 and 97 is substantially the same as that of the radial vibration force (magnetic vibration force) acting on the tooth 95. In contrast, the direction of the radial vibration force acting on each of the teeth 91 and 97 is reversed to that of the radial vibration force (magnetic vibration force) acting on the tooth 95.

The sum of the radial vibration forces acting on the teeth 91 and 95 circumferentially adjacent to each other is smaller than each radial vibration force acting on each of the teeth 91, 95, and 97.

In other words, the absolute value of the sum of the change ΔΦa of each of the magnetic fluxes through each of the inner peripheries of the teeth 91 and 97 and the change ΔΦb of the magnetic fluxes through the inner periphery of the tooth 95, which is represented as “|ΔΦa+ΔΦb|”, is smaller than each of the absolute value of the change ΔΦa, which is represented as “|ΔΦa|” and that of the change ΔΦb, which is represented as “|ΔΦb|”.

This allows superimposition of the higher-order harmonics acting on the pair of teeth 91 and 95 to be smaller than the higher-order harmonics acting on each of the teeth 91, 95 and 97.

Similarly, the sum of the radial vibration forces acting on the teeth 95 and 97 circumferentially adjacent to each other is smaller than each radial vibration force acting on each of the teeth 91, 95 and 97. This allows superimposition of the higher-order harmonics acting on the pair of teeth 95 and 97 to be smaller than the higher-order harmonics acting on each of the teeth 91, 95 and 97.

The sum of the radial vibration forces acting on the pair of teeth 95 and 97, which are circumferentially adjacent to each other and substantially assumed to the same source of vibration, is therefore smaller than each of the radial vibration forces acting on each of the teeth 91, 95, and 97.

Similarly, the sum of the radial vibration forces acting on the pair of teeth 91 and 95, which are circumferentially adjacent to each other and substantially assumed to the same source of vibration, is therefore smaller than each of the radial vibration forces acting on each of the teeth 91, 95, and 97. This permits the total of the higher-order harmonics in the magnetic noises to decrease.

As described above, in the second embodiment, the IPM motor M4 is configured such that, when the circumferential positions of the fist change regions 13D are aligned with the circumferential positions of the teeth 91 and 97, respectively, the circumferential position of one of the second change regions 14D is aligned with the circumferential position of the tooth 95. This configuration of the IPM motor M4 permits the magnetic noises to be effectively reduced.

In contrast, if the circumferential positions of the first change regions 13D are aligned with the circumferential positions of the teeth 91 and 97, respectively, the circumferential position of one of the second change regions 14D is out of alignment with the circumferential position of the tooth 95 by the had of the slot pitch, the magnetic noises may relatively increase.

One preferable range of the positional relationships between one of the first change regions 13D and one of the second change regions 14D, which is adjacent to each other through one of the magnetic-pole region 11D, is therefore determined as follows.

Specifically, it is assumed that the circumferential position of one of the first change regions 13D is aligned with the circumferential position of one of the teeth 91 and 97 at a time tx. At the time tx, the circumferential position of one of the second change regions 14D, which is adjacent to the one of the first change regions 13 through one of the magnetic-pole region 11D, is preferably located within the range from −0.2 slot pitch to 0.2 slot pitch on a coordinate axis. The coordinate axis is directed along the circumferential direction to pass through the circumferential position of the inner periphery of the teeth 95 as the point of origin.

Incidentally, the circumferential positions of the first and second change regions 13D and 14D correspond to the circumferential center positions of the corresponding other end portions of the first and second flux barriers 4X and 5X, respectively. In addition, the circumferential positions of the first and second change regions 13D and 14D correspond to the circumferential center positions of the corresponding thin-walled portions 6D that is magnetically saturated by the magnetic fluxes of the permanent magnets 3.

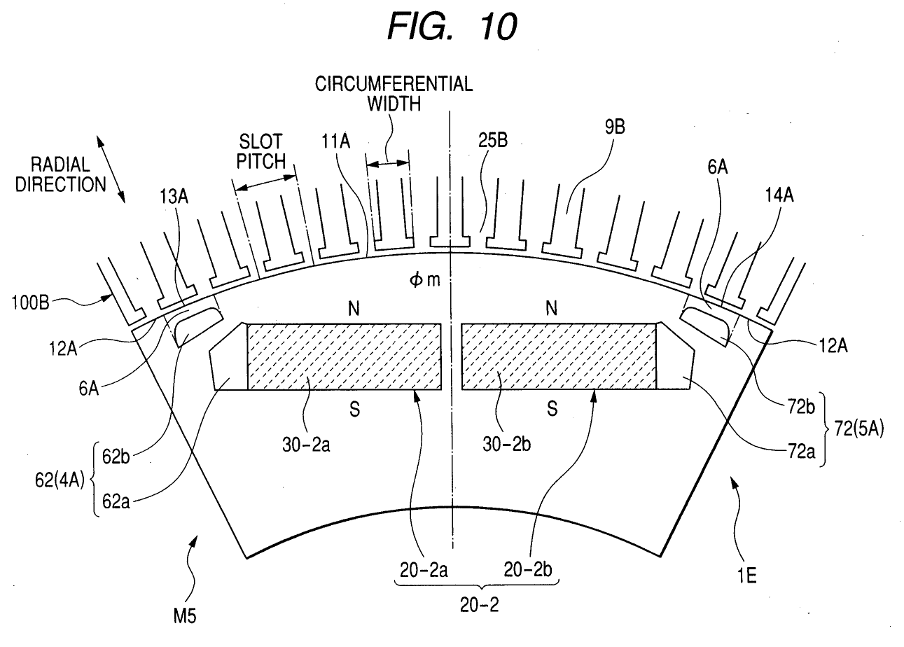

FIG. 10 is an example of the structure of an IPM motor MS. The IPM motor M5 is provided with a rotor core 1E basically having the same structure of the rotor core 1A shown in FIG. 4 and applying the flux barrier arrangement according to the second embodiment In addition, the IPM motor M5 is provided with a stator core 100B having a plurality of slots 25B arranged in the circumferential direction of the stator core 100B with regular pitches.

The stator core 100B also has teeth 9B formed between the slots 25B, respectively. In the example, the number of twelve teeth 9B are provided to correspond to the rotation of the rotor core 1E by the electric angle of π corresponding to one magnetic-pole pitch. Specifically, the number of twelve teeth 9B are provided for each phase and each magnetic-pole.

To elements of the rotor core 1E and those of the rotor core 1A, which are substantially identical with each other, the same reference characters are assigned, respectively.

Specifically, the rotor core 1E is configured such that, when the circumferential position of the first change region 13A corresponding to the first flux barrier element 62b is aligned with the circumferential position of one of the teeth 9B, the circumferential position of one of the second change regions 14A corresponding to the second flux barrier 72b is aligned with the circumferential position of another one of the teeth 9B.

In addition, when the circumferential position of the first change region 13A corresponding to the first flux barrier element 62b is aligned with the circumferential position of one of the teeth 9B, at least one of the teeth 9B is arranged to face at least one of the q-axis magnetic-pole regions 12A.

The circumferential width of each of the first and second flux barrier elements (62b and 72b) is substantially set to 0.6 to 0.9 times one slot pitch.

As a result of experiments and analyses, when the circumferential width of at least one of the first or second change regions (corresponding at least one of the flux barrier elements) is too short with respect to the circumferential width of the inner periphery of at least one of the teeth 9B, magnetic fluxes increase; these magnetic fluxes flow from the magnetic-pole region 11A adjacent to the at least one of the first or second change regions to the q-axis magnetic-pole region 12A adjacent to the magnetic-pole region 11A through the air gap, the inner periphery of the at least one of the teeth 9B, and the air gap.

These magnetic fluxes increase radially magnetic attractive forces attracting the at least one of the teeth 9B to the rotor core 1E, in other words, radially magnetic vibration forces acting on the at least one of the teeth 9. This may cause the higher-order harmonics in the magnetic noises to increase.

In contrast, when the circumferential width of at least one of the first or second change regions (corresponding at least one of the first or second flux barrier elements) is too long with respect to the circumferential width of the inner periphery of at least one of the teeth 9B, the magnetic flux densities on the inner periphery of the at least one of the teeth 9B radially facing the at least one of the first of second change regions are lower than those on the inner periphery of the at least one of the teeth 93 facing at least one of the magnetic-pole regions 11A and q-axis magnetic-pole regions 12A.

This causes the change of amount of magnetic fluxes radially passing through the inner periphery of the at least one of the teeth 9B to increase as compared with the case where the circumferential width of the at least one of the first or change regions (the circumferential width of the corresponding first or second flus barrier element) is too short with respect to the circumferential width of the inner periphery of the at least one of the teeth 9B. This may cause the higher-order harmonics in the magnetic noises to increase.

Increase of the higher-order harmonics will be described hereinafter in detail.

In cases where the circumferential width of each of the teeth 9B (slot pitch) is too short with respect to the circumferential width of at least one of the first or second change regions 13A or 14A (corresponding at least one of the flux barrier elements), when the circumferential position of at least one of the first or second change regions 13A or 14A is aligned with at least one of the teeth 9B, the amount of magnetic fluxes flowing from the circumferential position of at least one of the first or second change regions 13A or 14A to the at least one of the teeth 9B is smaller than that of magnetic fluxes flowing from the circumferential position of each of the magnetic-pole regions 11A and the q-axis magnetic-pole regions 12A.

The magnetic fluxes through the at least one of the teeth 9B, which faces at least one of the first and second change regions 13A and 14A, are smaller as compared with the case where the at least one of the teeth 9B faces one of the magnetic-pole regions 11A and the q-axis magnetic-pole regions 12A.

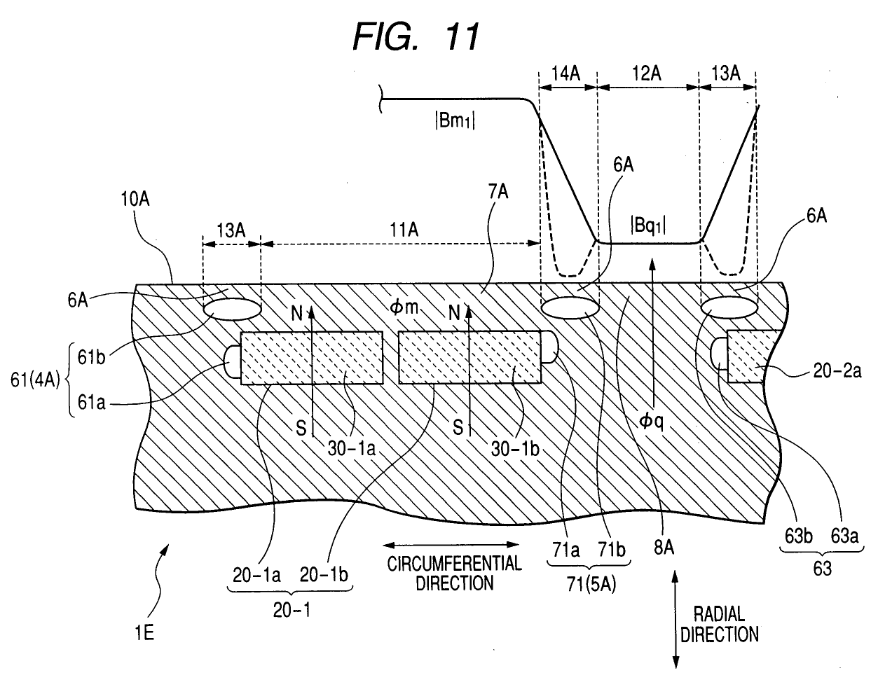

Specifically, the magnetic-pole density on at least one of the first and second change regions 13A and 14A is not assumed to the average of the absolute value of the magnetic-pole density Bm1 on the magnetic-pole region 11A adjacent to the at least one of the first change regions 13A and the absolute value of the q-axis magnetic-pole density Bq1 on the q-axis magnetic-pole region 12 adjacent to the at least one of the first change regions 13; these magnetic-pole density Bm1 and q-axis magnetic-pole density Bq1 are illustrated by solid line in FIG. 11.

That is, the magnetic-pole density on at least one of the first and second change regions 13A and 14A is lower than the average of the absolute value of the magnetic-pole density Bm1 and of the absolute value of the q-axis magnetic-pole density Bq1; this magnetic-pole density on at least one of the first and second change regions 13A and 14A is illustrated by a broken line in FIG. 11. This is likely because the inner periphery of the at least one of the teeth 9B faces one of the thin-walled portions 6A assumed to serve as a nonmagnetic element.

In a case where the magnetic flux density on one of the teeth 9B when at least one of the first and second change regions 13A and 14A faces the one of the teeth 9B is represented as Bmin, magnetic flux change ΔBt with the rotation of the rotor core 1E is represented as “Bm-Bmin”.

In contrast, in a case where the circumferential width of each of the teeth 9B, in other words, the slot pitch is sufficiently longer than the circumferential width of each of the first and second change regions 13A and 14A corresponding to the other end portions of the flux barrier elements), when the circumferential position of at least one of the first and second change regions 13A and 14A is aligned with the circumferential position of one of the teeth 9B, one circumferential end of the inner periphery of the at least one of the teeth 9B faces one of the magnetic-pole regions 11A, and the other circumferential end thereof faces one of the q-axis magnetic-pole regions 12A. This allows magnetic fluxes to flow from the one of the magnetic-pole regions 1A to the one of the q-axis magnetic-pole regions 12A through the air gap, the one of the teeth 9B, and the air gap. This permits the one of the teeth 9B to be sufficiently attracted to the rotor core 1E, causing the average magnetic-pole density on the inner periphery of one of the teeth 9B to increase.

When at least one of the first and second change regions 13A and 14A has passed directly in front of the inner periphery of one of the teeth 9B, therefore, the magnetic-pole density on the inner periphery of one of the teeth 9B is assumed to be continuously changed from one of the magnetic-pole density on the magnetic-pole region 11A adjacent to the at least one of the first and second change regions 13A and 14A and the q-axis magnetic-pole density on the q-axis magnetic-pole region 12A adjacent to at least one of the first and second change regions 13A and 14A.

As set forth above, in the second embodiment, there is a preferable range between the circumferential width of each of the first and second change regions 13A and 14A corresponding to the circumferential width of each of the other end portions of the first and second flux barrier elements and the slot pitch (the circumferential width of each of the teeth 9B); this preferable range allows the higher-order harmonics in the magnetic noises to be suppressed.

The experiments and analyses have shown that the circumferential width of each of the first and second change regions 13A and 14A is preferably shorter than the circumferential width of each of the teeth 93, and is preferably not less than the half of the circumferential width of each of the teeth 9B. In addition, the experiments and analyses have shown that the circumferential width of each of the first and second flux barrier elements (62b and 72b) is substantially set to preferably 0.6 to 0.9 times one slot pitch.

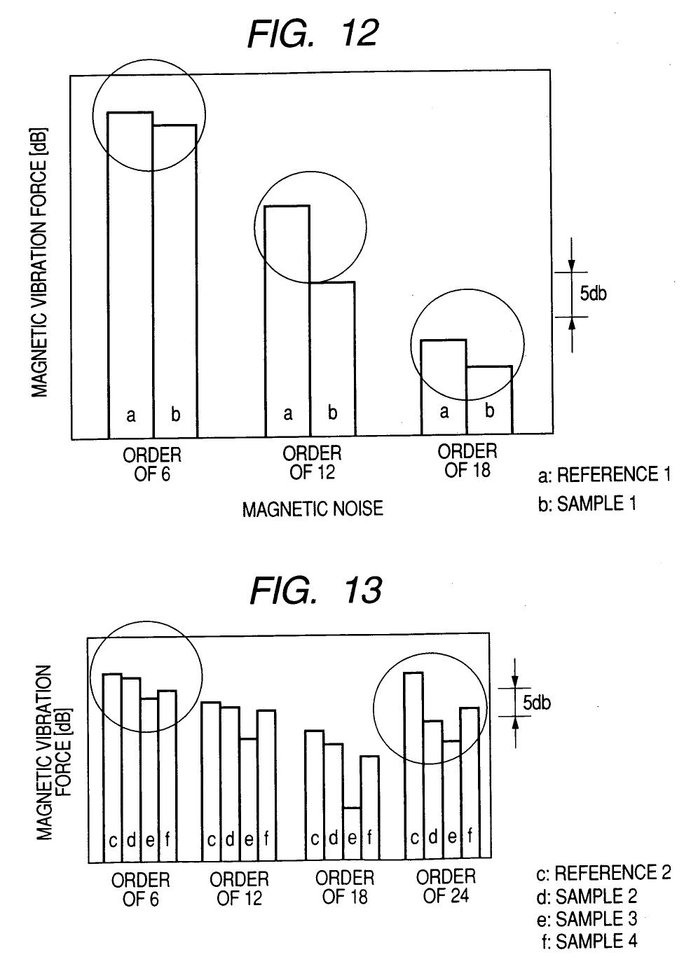

FIG. 12 shows a first test result. Specifically, FIG. 12 shows a comparison result of radial magnet vibration forces acting on each of the teeth of a sample 1 corresponding to the IPM motor M according to the first embodiment illustrated in FIG. 1 with a reference 1 of an IPM motor.

The IPM motor of the reference 1 is configured such that, on the basis of the structure of the IPM motor M, the first and second flux barriers 4 and 5 are symmetrical with to each other with respect to the radial directions each passing the center axis of each of the magnets 3. In addition, the first flux barriers 4 are rotationally symmetrical with each other through 45 degrees, and the second flux barriers 5 are rotationally symmetrical with each other through 45 degrees.

In FIG. 12, reference character “a” represents the magnetic vibration forces of the harmonics of the order 6, 12, and 18, which were caused from the reference 1. In contrast, reference character “b” represents the magnetic vibration forces of the harmonics of the order 6, 12, and 18, which were caused from the sample 1.

As clearly shown in FIG. 12, the structure of the sample 1 (IPM motor M) allows the higher-order harmonics in the magnetic noises to decrease.

FIG. 13 shows a second test result. Specifically, FIG. 13 shows a comparison result of radial magnet vibration forces acting on each of the teeth of each of samples 2 to 4 corresponding to the IPM motor M1 to M3 according to the first to third modifications illustrated in FIGS. 4, 6, and 7 with a reference 2 of an IPM motor.

The IPM motor of the reference 2 is configured such that, on the basis of the structure of the IPM motor M1, the first and second flux barriers 4A and 5A are symmetrical with to each other with respect to the radial directions each passing the center axis of each of the magnet elements 30. In addition, the first flux barriers 4A are rotationally symmetrical with each other through 45 degrees, and the second flux barriers 5A are rotationally metrical with each other through 45 degrees.

In FIG. 13, reference character “c” represents the magnetic vibration forces of the harmonics of the order 6, 12, 18, and 24, which were caused from the reference 2. In contrast, reference characters “d” to “f” represent the magnetic vibration forces of the harmonics of the order 6, 12, 18, and 24, which were caused from the sample 2 to 4, respectively.

As clearly shown in FIG. 13, the structure of each of the samples 2 to 4 (IPM motors M1 to M3) allows the higher-order harmonics in the magnetic noises to decrease.

In the first and second embodiments and their modifications, the IPM motors each is designed to inner-rotor motors, but the present invention can be applied to outer-rotor motors. Specifically, a rotor core is disposed around the outer periphery of a stator core such that the inner periphery of the rotor core is opposite to the outer periphery of the stator core with a predetermined air gap.

In the first and second embodiments and their modifications, the flat-plate like permanent magnets extending in parallel to the anal direction of the rotor core are used, but curved-plate like permanent magnets extending in parallel to the axial direction of the rotor core can be used.

In the first and second embodiments and their modifications, the present invention is applied to IPM motors, but the present invention can be applied to various types of interior permanent magnet electric rotating machines, such as IPM generators.

While there has been described what is at present considered to be the embodiments and modifications of the present invention, it will be understood that various modifications which are not described yet may be made therein, and it is intended to cover in the appended claims all such modifications as fall within the true spirit and scope of the invention.

What is claimed is:

1. An interior permanent magnet electric rotating machine comprising:
a stator core having a plurality of teeth circumferentially arranged with regular intervals; and
a rotor core with a periphery arranged to be opposite to a periphery of each of the teeth of the stator core with a predetermined air gap, the rotor core being supported to the rotating machine to be rotatable around the periphery of each of the teeth of the stator core,
the rotor core comprising:
a plurality of permanent magnets embedded in a plurality of slits, the plurality of slits being formed in the interior of the rotor core and circumferentially arranged to be opposite to the periphery of the rotor core with predetermined intervals;
a plurality of first flux barriers each having a first barrier portion and a first flux direction regulation portion, each of the first barrier portions being at least close to one circumferential end of each of the slits, the first flux direction regulation portions being circumferentially arranged with predetermined first intervals, each of the first flux direction regulation portions being closely opposite to a first region of the periphery of the rotor core with a predetermined thickness portion therebetween, each of the first flux regulation portions being configured to regulate a direction of a magnetic flu flowing through the predetermined thickness portion and to change a first magnetic flux density on the first region of the periphery of the rotor core;
a plurality of second flux barriers each having a second barrier portion and a second flux direction regulation portion, each of the second barrier portions being at least close to the other circumferential end of each of the slits, the second flux direction regulation portions being circumferentially arranged with predetermined second intervals, each of the second flux direction regulation portions being closely opposite to a second region of the periphery of the rotor core with a predetermined thickness portion therebetween, each of the second flux regulation portions being configured to regulate a direction of a magnetic flux flowing through the predetermined thickness portion and to change a second magnetic flux density on the second region of the periphery of the rotor core; and
a plurality of q-axis flux passing portions arranged between the first and second flux barriers, respectively, and configured to radially guide q-axis magnetic fluxes therethrough,
wherein at least one of at least one of the first intervals and at least one of the second intervals is different from corresponding at least one of at least one of the remaining first intervals and at least one of the remaining second intervals.

2. An interior permanent magnet electric rotating machine according to claim 1, wherein each of the first regions and the second regions has a first predetermined position, and each of the teeth has a second predetermined position on the periphery thereof, and wherein, when the rotor core is arranged with respect to the stator core such that the first predetermined position on at least one of the first regions and the second regions is aligned with the second predetermined position on at least one of the teeth, the first predetermined position on at least another one of the remaining first regions and the second regions is out of alignment with the second predetermined position on at least another one of the teeth.

3. An interior permanent magnet electric rotating machine according to claim 1, wherein each of the first flux barrier portions is connected to be communicated with the one circumferential end of each of the slits, each of the first flux direction regulation portions extends from each of the first flux barrier portions obliquely outwardly close to the first region of the periphery of the rotor core, each of the second flux barrier portions is connected to be communicated with the other circumferential end of each of the slits, and each of the second flux direction regulation portions extends from each of the second flux barrier portions obliquely outwardly close to the second region of the periphery of the rotor core.

4. An interior permanent magnet electric rotating machine according to claim 3, wherein radial widths of the thickness portions corresponding to the fist flux direction regulation portions are substantially the same as each other, and radial widths of the thickness portions corresponding to the second flux direction regulation portions are substantially the same as each other.

5. An interior permanent magnet electric rotating machine according to claim 1, wherein each of the first flux barrier portions is connected to be communicated with the one circumferential end of each of the slits, each of the first flux direction regulation portions is separated from each of the first flux barrier portions and arranged to be closely opposite to the first region of the periphery of the rotor core with the predetermined thickness portion therebetween, each of the second flux barrier portions is connected to be communicated with the other circumferential end of each of the slits, and each of the second flu direction regulation portions is separated from each of the second flux barrier portions and arranged to be closely opposite to the second region of the periphery of the rotor core with the predetermined thickness portion therebetween,

6. An interior permanent magnet electric rotating machine according to claim 2, wherein the first regions corresponding to the plurality of first flux direction regulation portions are divided into a plurality of groups, and when the first predetermined position on at least one of the first regions in one of the groups is aligned with the second predetermined position on at least one of the teeth, the first predetermined position on at least one of the first regions in the other groups is aligned with the second predetermined position on at least another one of the teeth, but the first predetermined positions on the remaining first regions in the one of the groups are disaligned with the second predetermined position on any teeth.

7. An interior permanent magnet electric rotating machine according to claim 6, wherein the rotor core is divided into a plurality of rotor core elements with respect to a predetermined angle, the number of rotor core elements corresponding to the number of the divided groups of the first regions.

8. An interior permanent magnet electric rotating machine according to claim 2, wherein the second regions corresponding to the plurality of second flux direction regulation portions are divided into a plurality of groups, and when the fist predetermined position on at least one of the second regions in one of the groups is aligned with the second predetermined position on at least one of the teeth, the first predetermined position on at least one of the second regions in the other groups is aligned with the second predetermined position on at least another one of the teeth, but the first predetermined positions on the remaining second regions in the one of the groups are disaligned with the second predetermined position on any teeth.

9. An interior permanent magnet electric rotating machine according to claim 8, wherein the rotor core is divided into a plurality of rotor core elements with respect to a predetermined angle, the number of rotor core elements corresponding to the number of the divided groups of the second regions.

10. An interior permanent magnet electric rotating machine according to claim 1, wherein the number of the teeth is an integer multiple of poles of the permanent magnets, and the plurality of slits are circumferentially arranged with an electric angle of π of the rotor core.

11. An interior permanent magnet electric rotating machine comprising:
a stator core having a plurality of teeth circumferentially arranged with rear intervals; and
a rotor core with a periphery arranged to be opposite to a periphery of each of the teeth of the stator core with a predetermined air gap, the rotor core being supported to the rotating machine to be rotatable around the periphery of the stator core,
the rotor core comprising:
a plurality of permanent magnets embedded in a plurality of slits, the plurality of slits being formed in the interior of the rotor core and circumferentially arranged to be opposite to the periphery of the rotor core with predetermined intervals;
a plurality of first flux barriers each having a first barrier portion and a first flux direction regulation portion, each of the first barrier portions being at least close to one circumferential end of each of the slits, the first flux direction regulation portions being circumferentially arranged with predetermined first intervals, each of the first flux direction regulation portions being closely opposite to a first region of the periphery of the rotor core with a predetermined thickness portion therebetween, each of the first flux regulation portions being configured to regulate a direction of a magnetic flux flowing through the predetermined thickness portion and to change a first magnetic flux density on the first region of the periphery of the rotor core;
a plurality of second flux barriers each having a second barrier portion and a second flux direction regulation portion, each of the second barrier portions being at least close to the other circumferential end of each of the slits, the second flux direction regulation portions being circumferentially arranged with predetermined second intervals, each of the second flux direction regulation portions being closely opposite to a second region of the periphery of the rotor core with a predetermined thickness portion therebetween, each of the second flux regulation portions being configured to regulate a direction of a magnetic flux flowing through the predetermined thickness portion and to change a second magnetic flux density on the second region of the periphery of the rotor core; and
a plurality of q-axis flux passing portions arranged between the first and second flux barriers, respectively, and configured to radially guide q-axis magnetic fluxes therethrough,
wherein, when at least one of the first regions has passed directly in front of the periphery of one of the teeth for a predetermined time interval, the at least one of the first regions creates first change of magnetic fluxes through the periphery of the one of the teeth, and at least one of the second regions adjacent to the at least one of the first regions creates second change of magnetic fluxes through the periphery of another one of the teeth during the time interval, another one of the teeth being close to the at least one of the second regions during the time interval, and wherein, when the first change is represented as ΔΦa and the second change is represented as ΔΦb, the at least one of the first regions and the at least one of the second regions adjacent thereto are arranged such that an absolute value of the sum of the first change ΔΦa and the second change ΔΦb is not more than any one of an absolute value of the first change ΔΦa and an absolute value of the second change ΔΦb.

12. An interior permanent magnet electric rotating machine according to claim 11, wherein each of the first regions and the second regions has a first predetermined position, and each of the teeth has a second predetermined position on the periphery thereof, and wherein, when the first predetermined position of the at least one of the first regions is aligned with the second predetermined position of the periphery of the one of the teeth, the firs predetermined position of the at least one of the second regions adjacent to the at least one of the first regions is aligned with the second predetermined poison of the periphery of another one of the teeth.

13. An interior permanent magnet electric rotating machine comprising:
a stator core having a plurality of teeth circumferentially arranged with regular intervals; and
a rotor core with a periphery arranged to be opposite to a periphery of each of the teeth of the stator core with a predetermined air gap, the rotor core being supported to the rotating machine to be rotatable around the periphery of the stator core,
the rotor core comprising:
a plurality of permanent magnets embedded in a plurality of slits, the plurality of slits being formed in the interior of the rotor core and circumferentially arranged to be opposite to the periphery of the rotor core with predetermined intervals;
a plurality of first flux barriers each having a first barrier portion and a first flux direction regulation portion, each of the first barrier portions being at least close to one circumferential end of each of the slits, the first flux direction regulation portions being circumferentially arranged with predetermined first intervals, each of the first flux direction regulation portions being closely opposite to a first region of the periphery of the rotor core with a predetermined thickness portion therebetween, each of the first flux regulation portions being configured to regulate a direction of a magnetic flux flowing through the predetermined thickness portion and to change a first magnetic flux density on the first region of the periphery of the rotor core;
a plurality of second flux barriers each having a second barrier portion and a second flux direction regulation portion, each of the second barrier portions being at least close to the other circumferential end of each of the slits, the second flux direction regulation portions being circumferentially arranged with predetermined second intervals, each of the second flux direction regulation portions being closely opposite to a second region of the periphery of the rotor core with a predetermined thickness portion therebetween, each of the second flux regulation portions being configured to regulate a direction of a magnetic flux flowing through the predetermined thickness portion and to change a second magnetic flux density on the second region of the periphery of the rotor core; and
a plurality of q-axis flux passing portions arranged between the first and second flux barriers, respectively, and configured to radially guide q-axis magnetic fluxes therethrough,
wherein each of the thickness portions corresponding to the first and second flux direction regulation portions has a circumferential width, the circumferential width being 0.6 to 0.9 times a circumferential width of each of the teeth.
